(19) United States
(12) Patent Application Publication
(10) Pub. No.: US 2026/0089493 A1
(43) Pub. Date: Mar. 26, 2026

(54) RADIO ACCESS NETWORK DEPLOYMENT FOR PRIVACY-PRESERVING AGGREGATION

(71) Applicant: Apple Inc., Cupertino, CA (US)

(72) Inventors: Milan Zivkovic, Munich (DE); Alperen Gundogan, Munich (DE); Anousheh Gholami Ghavamabad, San Diego, CA (US); Panagiotis Botsinis, Munich (DE); Said Medjkouh, San Diego, CA (US); Sameh M. Eldessoki, Munich (DE); Tarik Tabet, Carlsbad, CA (US)

(21) Appl. No.: 19/392,128

(22) Filed: Nov. 17, 2025

Related U.S. Application Data
(63) Continuation-in-part of application No. 18/892,281, filed on Sep. 20, 2024.

(30) Foreign Application Priority Data
Nov. 19, 2024 (GR) 20240100826

(51) Int. Cl. H04W 12/02; H04W 12/03

(52) U.S. Cl. CPC H04W 12/02; H04W 12/03

(57) ABSTRACT

A method for privacy-aware data aggregation is described. The method includes receiving a first request for privacy-preserving aggregation (PPA) capability information; transmitting the PPA capability information in accordance with the first request; receiving a second request for a PPA contextual data report; and transmitting the PPA contextual data report in accordance with the second request. The PPA capability information may indicate a capability of a user equipment (UE) to provide at least one of network context information or UE context information for the purpose of privacy-aware data aggregation.

### CROSS-REFERENCE TO RELATED APPLICATIONS

This application is a continuation-in-part of U.S. patent application Ser. No. 18/892,281, filed Sep. 20, 2024. This application also claims the benefit of Greek patent application No. 20240100826, filed Nov. 19, 2024. Both of the foregoing applications are incorporated herein by reference in their entirety.

### TECHNICAL FIELD

The present disclosure relates generally to wireless communication, and more specifically to a radio access network (RAN) deployment for privacy-preserving aggregation (PPA).

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as orthogonal frequency-division multiple access (OFDMA), multiple input multiple output (MIMO), advanced channel coding, massive MIMO, beamforming, and/or other features.

### SUMMARY

One aspect of the present disclosure relates to a method including: receiving an indication of a privacy-preserving configuration for secure data aggregation, the privacy-preserving configuration including one or more parameters to use for splitting user equipment (UE) data into a set of cryptographically secure input shares; generating the set of cryptographically secure input shares according to the one or more parameters of the privacy-preserving configuration; and instructing radio frequency (RF) circuitry to transmit the set of cryptographically secure input shares containing the UE data.

In some implementations, the method further includes instructing the RF circuitry to transmit an indication of a privacy or sensitivity level associated with the UE data.

In some implementations, the one or more parameters of the privacy-preserving configuration include at least one of a random number generator (RNG) or a secret-shared non-interactive proof (SNIP) configuration to use for splitting the UE data into the set of cryptographically secure input shares.

In some implementations, the method further includes: receiving, during a downlink protocol data unit (PDU) session, data associated with a machine learning (ML) model; and training the ML model with the UE data in accordance with the one or more parameters of the privacy-preserving configuration for secure data aggregation.

In some implementations, the method further includes instructing the RF circuitry to transmit, during an uplink PDU session, data associated with the ML model trained with the UE data in accordance with the one or more parameters of the privacy-preserving configuration for secure data aggregation.

In some implementations, instructing the RF circuitry to transmit the set of cryptographically secure input shares includes outputting the set of cryptographically secure input shares for transmission to a respective set of application functions (AFs) that are configured to convert the set of cryptographically secure input shares to a respective set of aggregated output shares.

In some implementations, the method further includes: outputting a request for analytic data; and receiving the analytic data from a network data analytics function (NWDAF) that is configured to generate the analytic data based at least on the set of cryptographically secure input shares containing the UE data.

Another aspect of the present disclosure relates to a method including: transmitting an indication of a privacy-preserving configuration for secure data aggregation, the privacy-preserving configuration including one or more parameters to use for splitting UE data into a set of cryptographically secure input shares; receiving a set of aggregated output shares computed from the set of cryptographically secure input shares containing the UE data; and generating analytic data based at least on the set of aggregated output shares computed from the set of cryptographically secure input shares containing the UE data.

In some implementations, the method further includes: receiving an indication of a privacy or sensitivity level associated with the UE data; and selecting a cooperative data collection scheme based at least on the privacy or sensitivity level associated with the UE data, where the analytic data is generated according to the selected cooperative data collection scheme.

In some implementations, the method further includes: receiving, from at least one UE or network function (NF), a request for the analytic data; and outputting the analytic data for transmission to the at least one UE or NF in accordance with the request.

In some implementations, the method further includes: retrieving, from an analytics data repository function (ADRF), data associated with an ML model; and outputting the data associated with the ML model during a downlink PDU session.

In some implementations, the method further includes training an ML model based on the set of aggregated output shares computed from the set of cryptographically secure input shares containing the UE data.

In some implementations, the analytic data is generated using the ML model trained on the set of aggregated output shares computed from the set of cryptographically secure input shares containing the UE data.

Another aspect of the present disclosure relates to a method including: receiving an indication of a privacy-preserving configuration for secure data aggregation, the privacy-preserving configuration including one or more parameters to use for converting a cryptographically secure input share containing UE data to an aggregated output share; receiving the cryptographically secure input share containing the UE data; and converting the cryptographically secure input share to the aggregated output share in accordance with the one or more parameters of the privacy-preserving configuration for secure data aggregation.

In some implementations, the method further includes outputting the aggregated output share for transmission to an NWDAF that is configured to generate analytic data based at least on the aggregated output share.

In some implementations, the method further includes: receiving a SNIP associated with the cryptographically secure input share; and prior to converting the cryptographically secure input share to the aggregated output share, verifying the cryptographically secure input share based at least on the SNIP associated with the cryptographically secure input share.

In some implementations, verifying the cryptographically secure input share includes exchanging the SNIP with one or more AFs that are configured to receive and process other cryptographically secure input shares containing the UE data.

In some implementations, the method further includes registering for one or more data collection, model training, or analytic services via a trusted domain or a network exposure function (NEF).

In some implementations, the method further includes receiving, during an uplink PDU session, inferred data generated by a local privacy-preserving ML model.

In some implementations, the method further includes outputting the inferred data to a NWDAF that is configured to generate analytic data based at least on the inferred data.

Another aspect of the present disclosure relates to one or more processors configured to, when executing instructions stored in a memory, perform any of the foregoing operations.

Another aspect of the present disclosure relates to a device comprising processing circuitry configured to perform any of the foregoing operations.

Another aspect of the present disclosure relates to an apparatus comprising one or more processors and memory storing instructions that, when executed by the one or more processors, cause the apparatus to perform any of the foregoing operations.

Another aspect of the present disclosure relates to a non-transitory computer-readable medium storing instructions that, when executed by one or more processors, cause the one or more processors to perform any of the foregoing operations.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIGS. 2A and 2B illustrate example signaling diagrams, according to some implementations.

FIG. 3 illustrates an example privacy-preserving architecture, according to some implementations.

FIGS. 4 and 5 illustrate example network diagrams, according to some implementations.

FIGS. 6A and 6B illustrate an example process flow, according to some implementations.

FIG. 7A illustrates an example data flow of a distributed aggregation function, according to some implementations.

FIG. 7B illustrates an example aggregation system architecture, according to some implementations.

FIGS. 8A-8F illustrate another example process flow, according to some implementations.

FIGS. 9A and 9B illustrate another example process flow, according to some implementations.

FIGS. 10A and 10B illustrate another example process flow, according to some implementations.

FIGS. 11, 12, and 13 illustrate flowcharts of example methods, according to some implementations.

FIG. 14 illustrates an example UE, according to some implementations.

FIG. 15 illustrates an example access node, according to some implementations.

FIGS. 16A and 16B illustrate an example process flow, according to some implementations.

FIGS. 17A and 17B illustrate another example process flow, according to some implementations.

FIGS. 18 and 19 illustrate flowcharts of example methods, according to some implementations.

### DETAILED DESCRIPTION

Some wireless communication systems can support privacy-aware data collection, learning, and analytic services. To enable machine learning (ML)-based cooperative intelligence techniques such as cooperative learning (where network nodes collaborative learn a shared ML model), data and model information may be shared amongst network nodes. User equipment (UE) data can be managed locally or shared with the network based on privacy-aware data classifications and trust levels between the UE and the network. Different types of UE data can be classified according to privacy/sensitivity levels that determine which cooperative data sharing model is used for model training.

In some data collection schemes, a network data analytics function (NWDAF) may provide analytic data to one or more fifth generation (5G) core network functions (NFs) to enable autonomous network operations and service management, allowing for the integration of various data-driven artificial intelligence (AI) and ML technologies into 5G networks. Acting as a service consumer, the NWDAF may collect data from various sources and use the collected data for analytics, measurements, predictions, etc. However, there are some privacy concerns with the current 5G data collection and analytics framework, as the UE application shares individual data with application functions (AFs), which can expose them to network operators.

Aspects of the present disclosure generally provide for integrating privacy-preserving data collection and learning into the Third Generation Partnership Project (3GPP) architecture for 5G and sixth generation (6G) wireless systems. The privacy-preserving data collection/learning techniques described herein leverage verifiable distributed aggregation functions (VDAFs) to facilitate secure data sharing between UEs and AFs. For example, a UE may split private/sensitive data into multiple input shares and send one input share to each AF participating in the data collection process. The AFs (also referred to as aggregators) may process the input shares and send the resulting data to the NWDAF (also referred to as the collector), which can use the data to compute aggregated statistics, network analytics, etc.

In some implementations, the UE may be configured to report privacy-preserving aggregation (PPA) capability information to assist the radio access network (RAN) with secure data aggregation. For example, a RAN node (such as a base station) may transmit a PPA capability request to solicit PPA capability information from the UE. The PPA capability information may indicate whether the UE can provide network context data (such as network measurements or configuration parameters) and/or UE context data (such as UE location data or application status information). The RAN node may configure the UE to provide a PPA contextual data report based on the PPA capability information. The PPA contextual data report may include one or more input shares associated with the network context data and/or the UE context data.

The data collection schemes described herein provide greater privacy preservation because the consumers of the network analytics only receive statistics associated with the collected UE data without compromising UE privacy. In other words, the sensitive/private UE data is never directly exposed on the network. For highly sensitive/private UE data (such as exact location or personal information), the network may share an ML model with the UE, and the UE may perform inference/training operations locally. Once complete, the UE may share the results with the network. This allows the network to glean helpful information from the UE without exposing the underlying data.

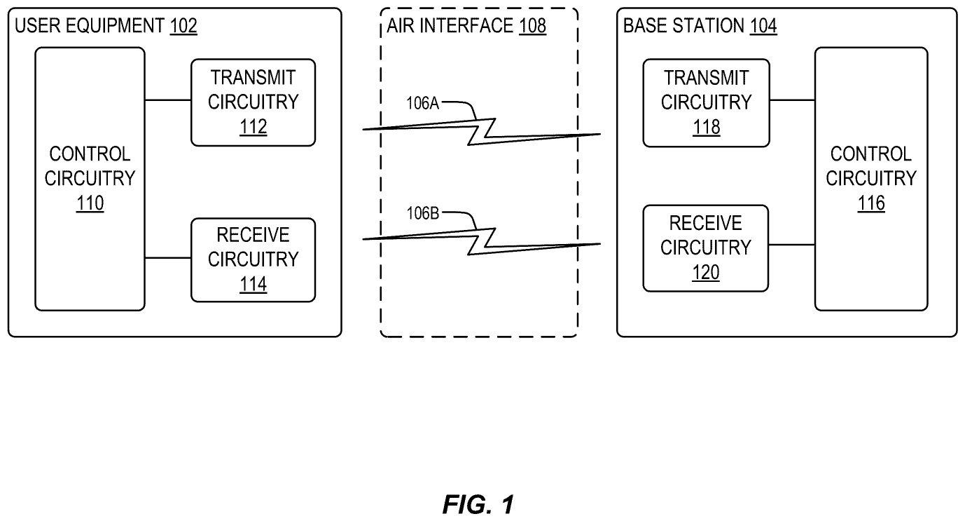

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be a E-UTRA (Evolved Universal Terrestrial Radio Access)-NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For instance, the control circuitry 110 can generate one or more cryptographically secure input shares according to one or more parameters of a privacy-preserving configuration for secure data aggregation.

The transmit circuitry 112 can perform various operations described herein. For example, the transmit circuitry 112 can transmit the one or more cryptographically secure input shares to one or more AFs that are configured to convert the cryptographically secure input shares to aggregated output shares. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation. The transmit circuitry 112 may be configured to receive block data from the control circuitry 110 for transmission on the air interface 108.

The receive circuitry 114 can perform various operations described herein. For instance, the receive circuitry 114 can receive network analytic data from an NWDAF that is configured to process the aggregated output shares from the AF. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates a base station 104. In some implementations, the base station 104 may be a 5G RAN, a next generation RAN, a Evolved Universal Terrestrial Radio Access Network (E-UTRAN), a non-terrestrial cell, or a legacy RAN, such as a Universal Terrestrial Radio Access Network (UTRAN). As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

Some aspects of the present disclosure relate to secure aggregation (in 6G architecture) and privacy-aware data collection and learning (e.g., training and inference). In particular, the techniques described herein can extend the 3GPP network architecture to support privacy-preserving collection and training through coordination signaling and message flow. The described techniques may also support privacy-aware learning among network nodes thought coordination signaling and message flow. In some implementations, a mode of data collection/aggregation may be selected based on the privacy/sensitivity of the underlying UE data (as described in greater detail below).

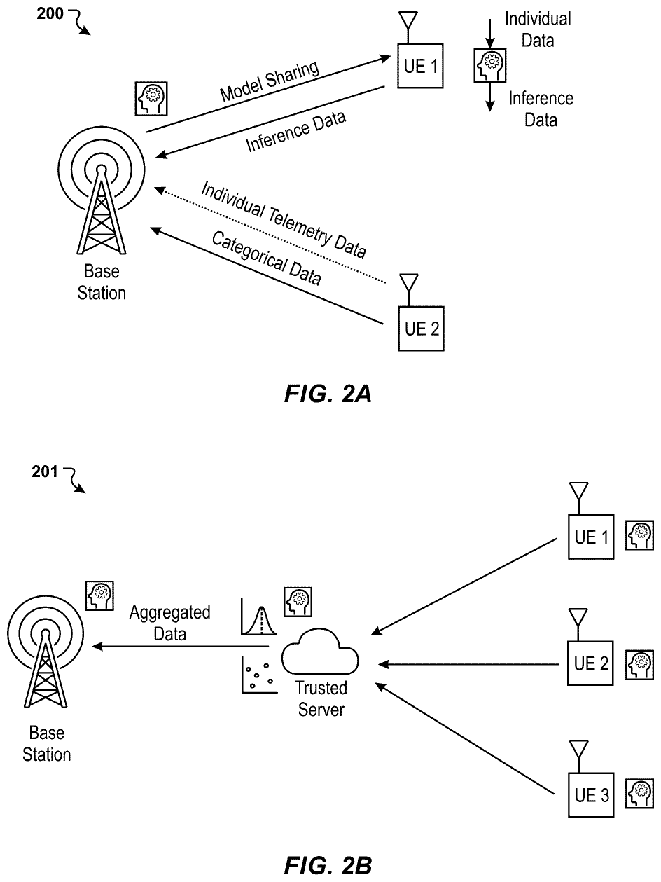

FIG. 2A illustrates an example signaling diagram 200, according to some implementations. The signaling diagram 200 may implement one or more aspects of the wireless network 100. For example, the signaling diagram 200 includes a first UE (UE 1) and a second UE (UE 2), which may be examples of the UE 102 depicted in FIG. 1. Likewise, the signaling diagram 200 includes a base station, which may be an example of the base station 104 depicted in FIG. 1.

The example signaling diagram 200 illustrates a framework for cooperative data and model sharing based on privacy/sensitivity level. Additional details about the framework depicted in FIG. 2A can be found in U.S. patent application Ser. No. 18/506,243, entitled “SYSTEMS, METHODS, AND DEVICES FOR UE-ASSISTED PRIVACY-AWARE DATA-DRIVEN NW CONTROL,” filed Nov. 10, 2023, the entire contents of which are incorporated by reference herein. Examples of different privacy/sensitivity levels are listed below in Table 1. As shown in FIG. 2A, UE 1 may infer individual private data using a network-shared model and share the inferred data with the base station. UE 2 may share individual non-private telemetry and/or categorical data with the base station.

TABLE 1
Example Privacy Levels of UE Data

| Privacy | | | |
|---|---|---|---|
| Level | Data Type | Description and Examples | Sharing Mode |
| 0 | Individual | Exact location, exact | Not shared with the network; |
| | user private | application used, exact | network shares the inference with |
| | data | behavior (sleeping), personal | the UE; UE performs inference on |
| | | information (e.g., age, sex, | it using private data; |
| | | weight) | UE sends the result to the network. |
| 1 | Individual | Statistics about network | UE might conditionally share |
| | connectivity | usage patterns (QoS | telemetry data (without any |
| | telemetry data | categories) over a defined | confidential information) with the |
| | | period of time | network. |
| 2 | Categorical | Connectivity context (no | UE shares data to the network to |
| | contextual | data, low traffic, high traffic) | inform about a connectivity |
| | user data | | contextual event (sub-seconds) or |
| | | | forecast (seconds, minutes). |
| 3 | Aggregated | Individual private data can | This federated data is a collection |
| | multi-user | be aggregated across | of user data that will be shared with |
| | data | multiple UEs to provide | the network in form of anonymized |
| | (federated | statistical and analytical | statistical quantities, histograms, |
| | data) | information about UEs | embeddings; the data can inform |
| | | without exposing individual | the network about different metrics |
| | | private information. | that can guide automation |
| | | | evaluation and resource planning. |

The privacy-aware data collection and learning techniques described herein involve signaling mechanisms that are based on data privacy level. For example, a network entity (such as an NF) may ask an NWDAF for analytics assistance (e.g., data/model training) using UE and/or network data. A UE (such as UE 1) may also initiate or ask the NWDAF for analytics assistance (e.g., data/model training) using UE or network data.

The NWDAF may perform the requested training/inference and provide analytics to the consumer (e.g., the NF, UE 1, UE 2). In some implementations, UE 1 may report the available data types (e.g., privacy/sensitivity levels). This information can be used to determine a suitable cooperative learning variant. If, for example, UE 1 has multiple data types with different privacy/sensitivity levels, multiple variants can be combined.

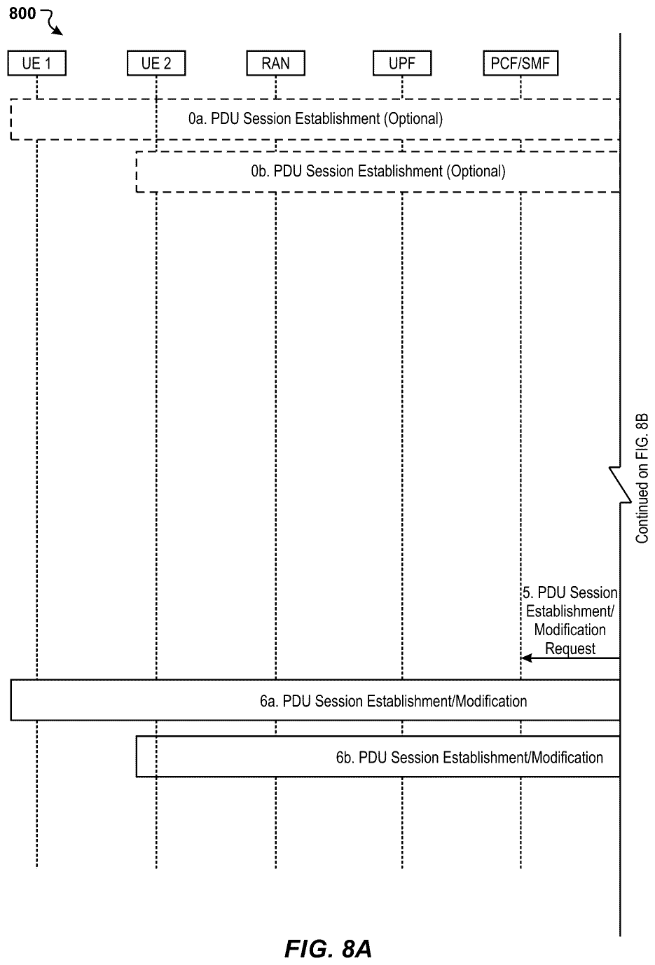

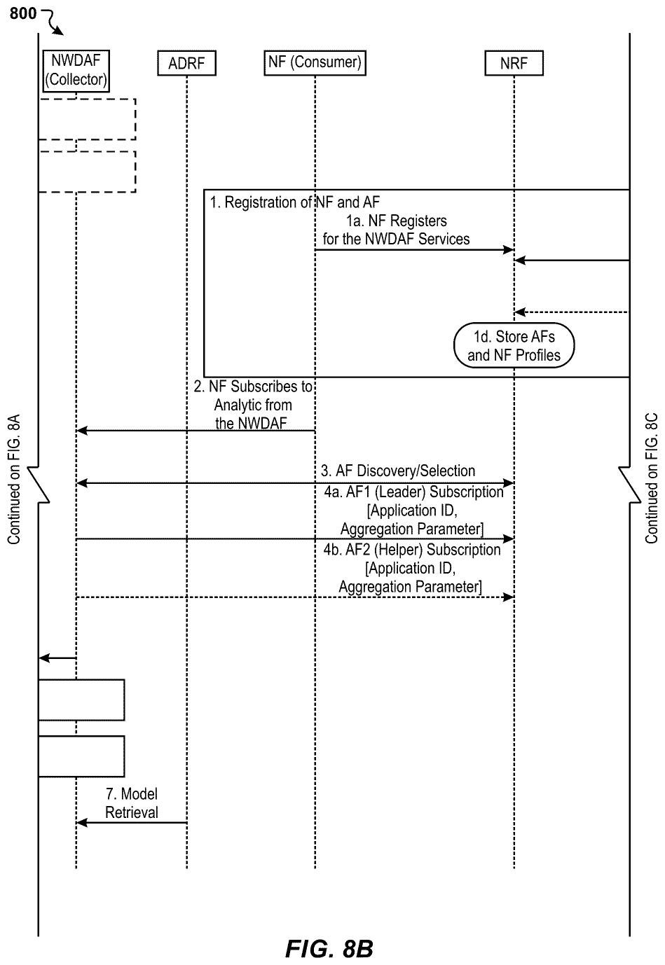

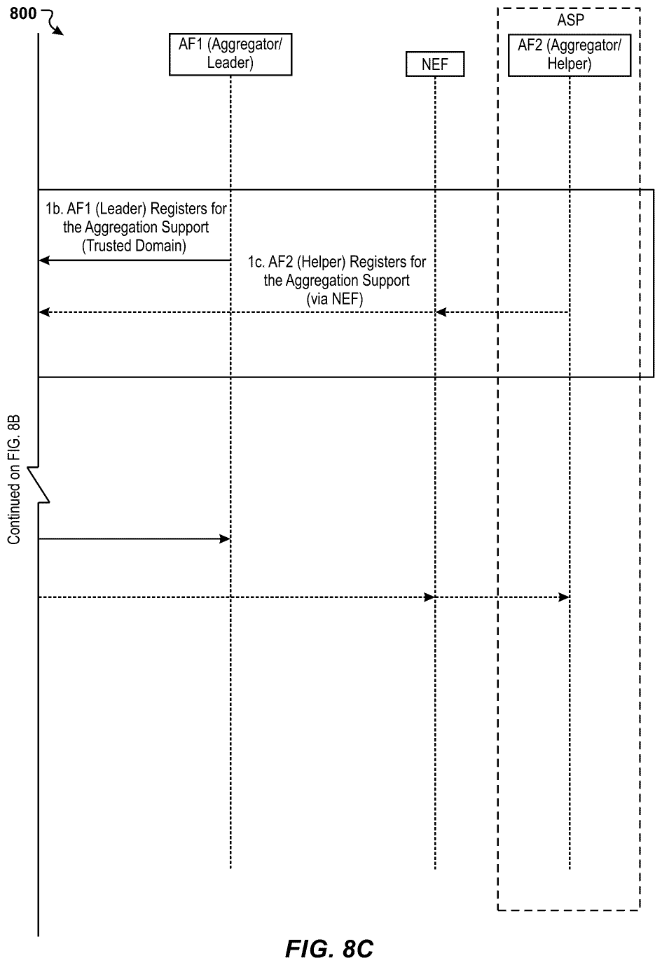

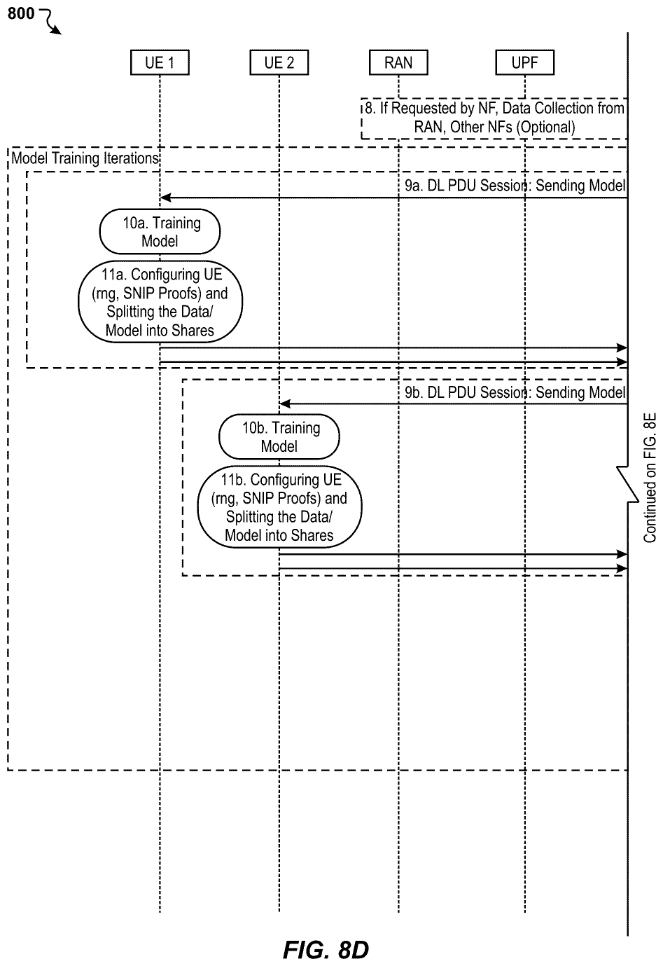

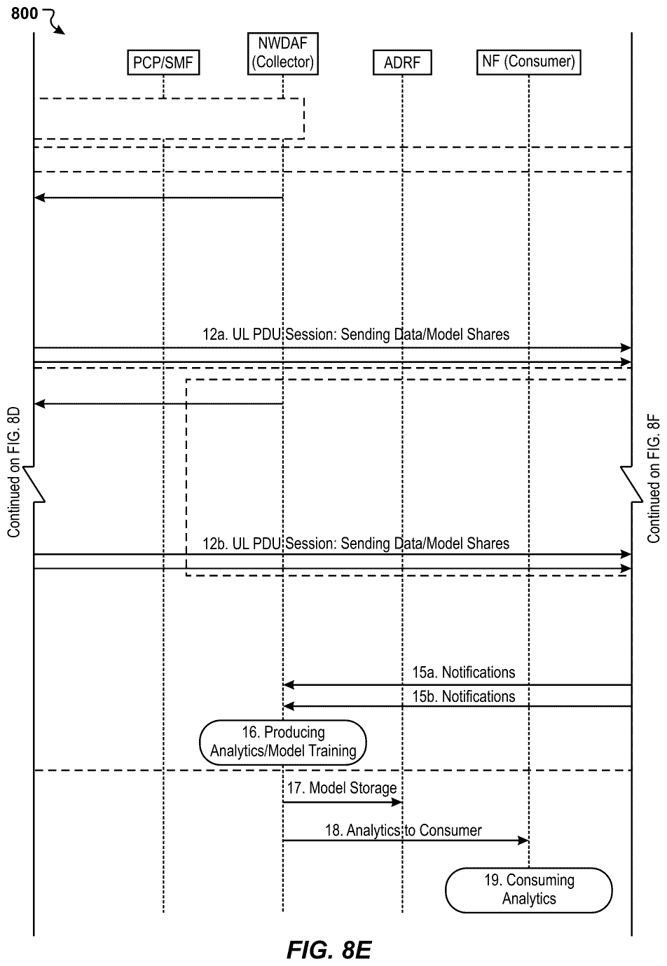

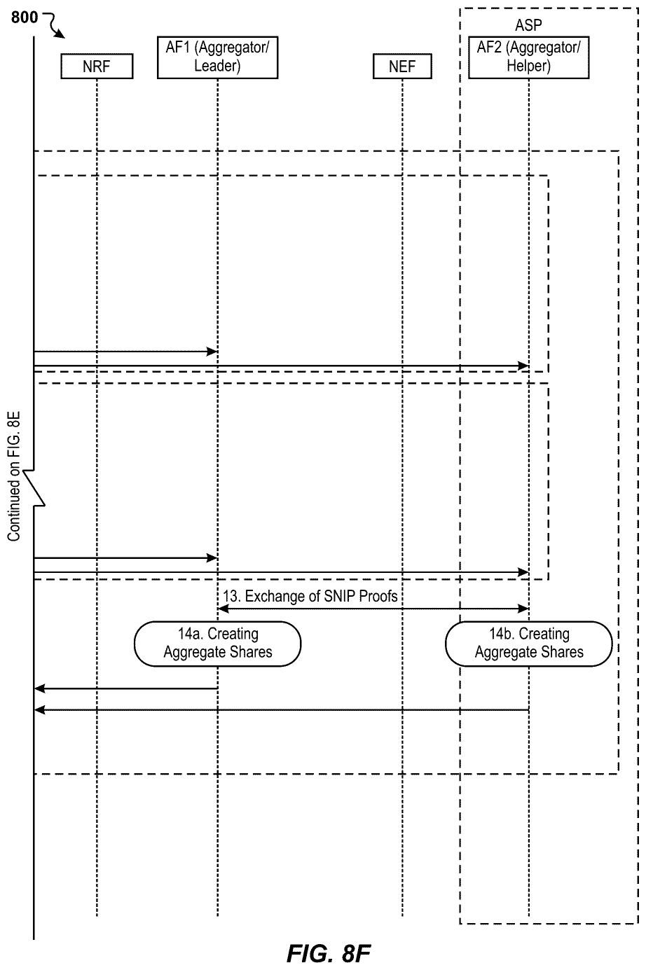

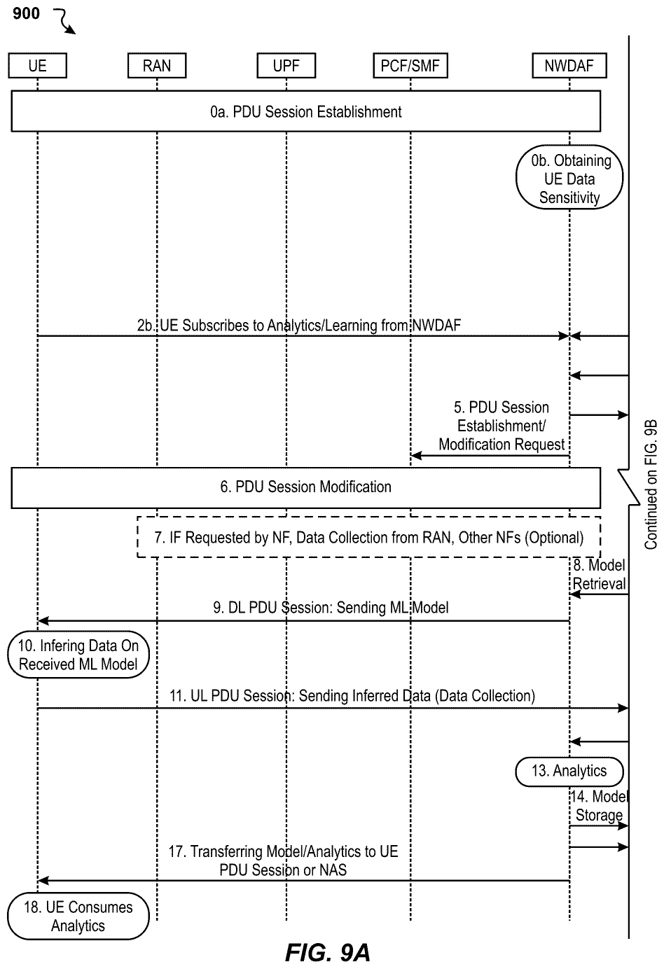

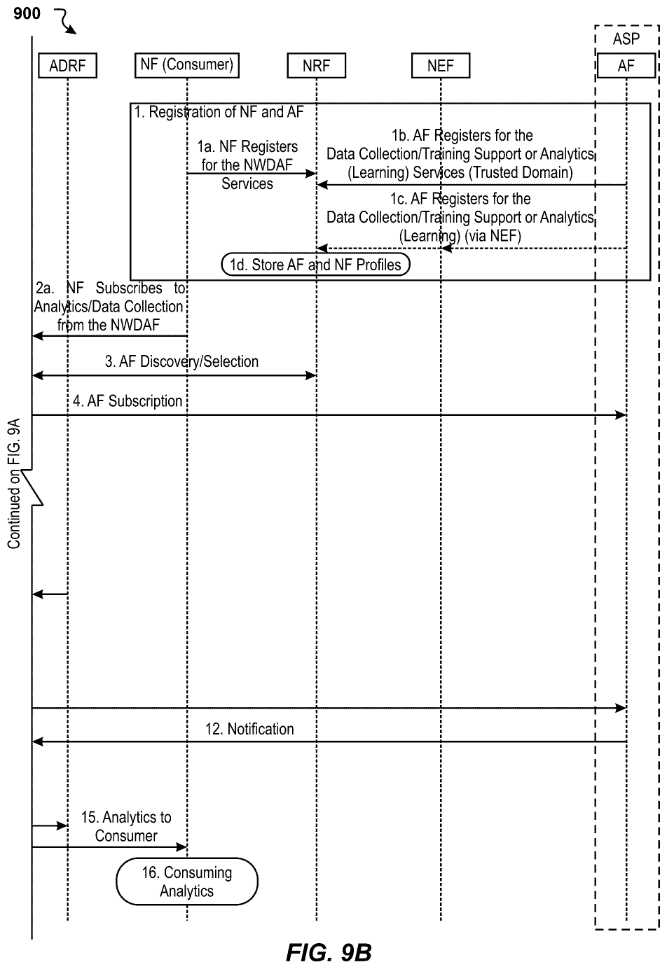

Multiple data collection and learning variants based on UE data privacy/sensitivity level are contemplated within the scope of the present disclosure. For privacy/sensitivity level 0, data can be trained using private federated learning or privacy-preserving data/model aggregation. This approach is shown in FIGS. 8A and 8B. For model inference, as shown in FIGS. 9A and 9B, the network sends the ML model to UE 1 (via a downlink PDU session) and UE 1 infers local data using the ML model. UE 1 can then send the inferred data back to the network during an uplink PDU session.

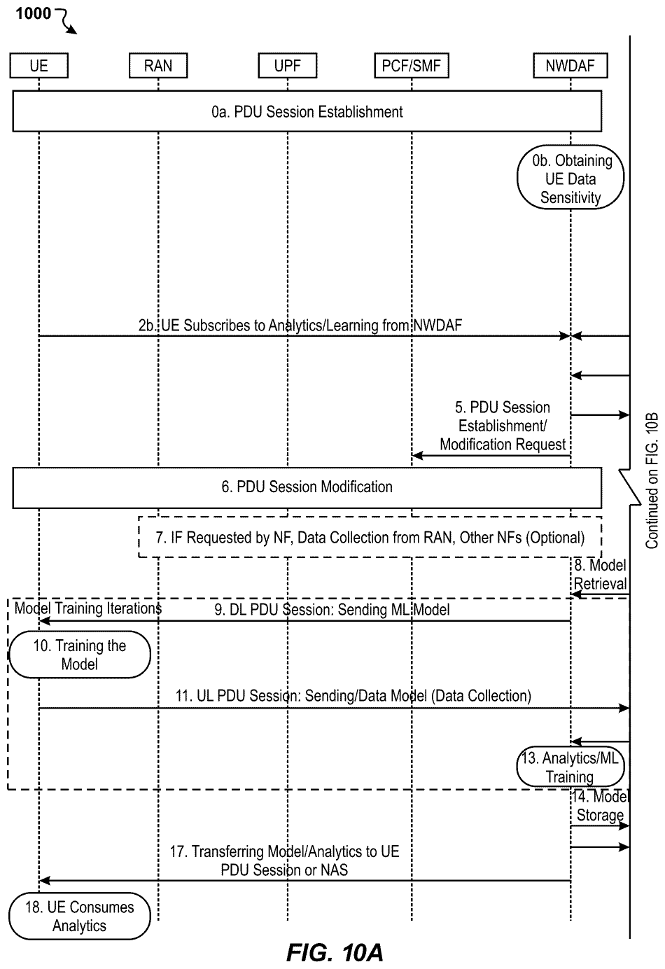

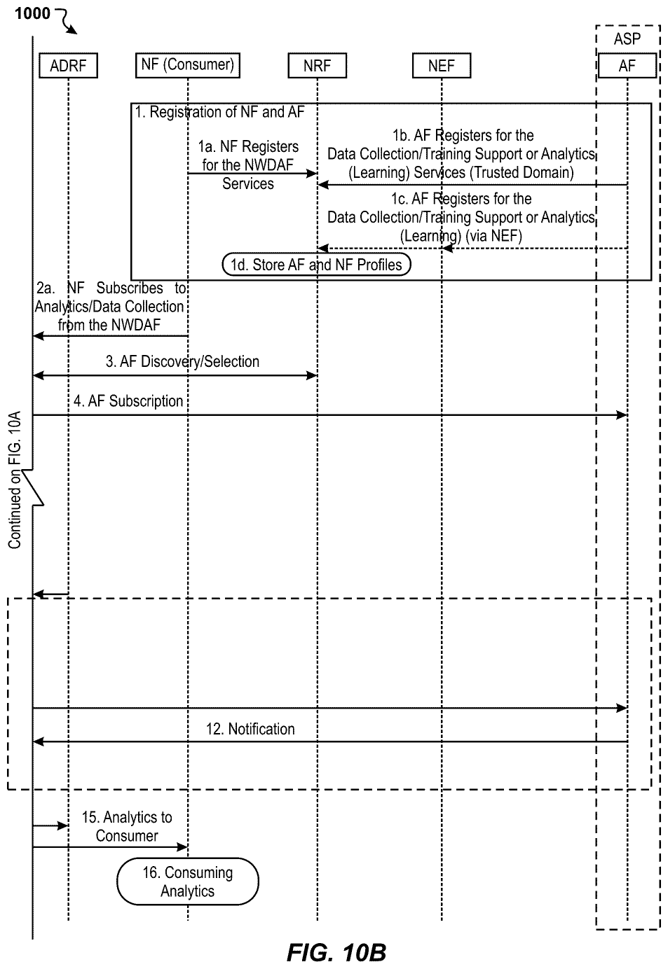

For privacy/sensitivity level 1 and 2, both data collection and learning/model training can be performed. This approach is shown in FIGS. 10A and 10B. Privacy-preserving data/model aggregation can be used for privacy/sensitivity level 3. This approach is shown in FIGS. 8A-8F. The proposed variants can be used, e.g., for cooperative learning among network nodes with different sensitivity levels.

FIG. 2B illustrates an example signaling diagram 201, according to some implementations. The signaling diagram 201 may implement one or more aspects of the wireless network 100. For example, the signaling diagram 201 includes a first UE (UE 1), a second UE (UE 2), and a third UE (UE 3), which may be examples of the UE 102 depicted in FIG. 1. Additionally, the signaling diagram 201 includes a base station, which may be an example of the base station 104 depicted in FIG. 1.

The example signaling diagram 201 illustrates a framework for cooperative data and model sharing based on privacy/sensitivity level. Additional details about the framework depicted in FIG. 2B can be found in U.S. patent application Ser. No. 18/506,243, entitled “SYSTEMS, METHODS, AND DEVICES FOR UE-ASSISTED PRIVACY-AWARE DATA-DRIVEN NW CONTROL,” filed Nov. 10, 2023, the entire contents of which are incorporated by reference herein. As shown in FIG. 2B, UE 1, UE 2, and UE 3 may provide data to a trusted server, which may aggregate and share the multi-user data and models with the base station. Using a trusted server helps facilitate privacy-preserving secure data aggregation.

The privacy-preserving techniques described herein extend the existing 3GPP NWDAF framework. Privacy-aware data collection and learning enables data-driven cooperation between network nodes. Based on UE data privacy classification (as shown in Table 1), different variants for data collection and learning can be integrated with the existing NWDAF framework.

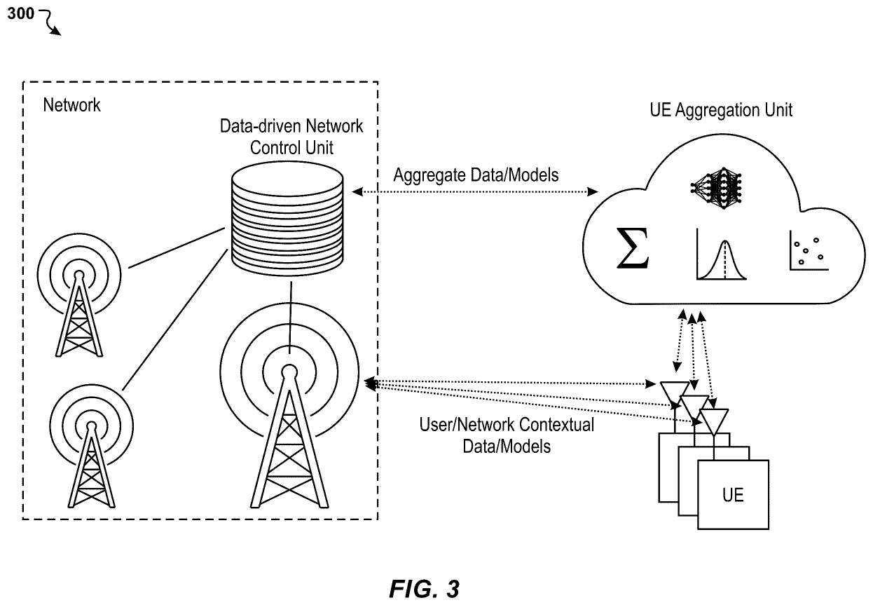

FIG. 3 illustrates an example privacy-preserving architecture 300, according to some implementations. The privacy-preserving architecture 300 may implement one or more aspects of the wireless network 100. For example, the privacy-preserving architecture 300 includes a UE, which may be examples of the UE 102 depicted in FIG. 1. Additionally, the privacy-preserving architecture 300 includes a network, which may include at least one base station 104. The privacy-preserving architecture 300 shown in FIG. 3 may support data collection, learning, and analytics. Additional details about the privacy-preserving architecture 300 can be found in U.S. patent application Ser. No. 18/506,243, entitled “SYSTEMS, METHODS, AND DEVICES FOR UE-ASSISTED PRIVACY-AWARE DATA-DRIVEN NW CONTROL,” filed Nov. 10, 2023, the entire contents of which are incorporated by reference herein.

As described herein, data and model sharing among network nodes helps to facilitate ML-based cooperative intelligence techniques such as cooperative learning, where network nodes collaboratively learn a shared model. UE data can either be owned locally or shared partially/totally based on privacy-aware data classification and trust levels between UEs and the network.

Different types of data can be characterized by privacy/sensitivity levels (shown in Table 1) that determine which data sharing cooperative model is used. The privacy-preserving architecture 300 shown in FIG. 3 can be used to collect data and perform learning and analytics (e.g., for privacy/sensitivity level 3). The privacy-preserving architecture 300 includes a UE aggregation unit that is an architectural element for privacy-preserving data aggregation using secure aggregation techniques. The privacy-preserving architecture 300 also includes a data-driven network control unit that receives UE collected data from the UE aggregator and helps the network to improve control and make more informed decisions.

Privacy-preserving data collection/learning schemes can leverage privacy-preserving cryptographic protocols like Prio, which are implemented by clients, aggregators (leader and helper), and a collector. The clients split data into shares and send them to different aggregators, which are responsible for aggregating UE data shares. The collector is an entity that obtains the aggregated UE data. The leader and the helper send aggregated shares to the collector, which computes the final aggregation results. One possible application of the Prio protocol in a cellular network architecture can be based on the NWDAF service framework (defined in 3GPP TS 23.288). The NWDAF provides analytics to 5G Core NFs to enable autonomous network operations and service management, allowing for the integration of various data-driven AI/ML technologies into 5G networks.

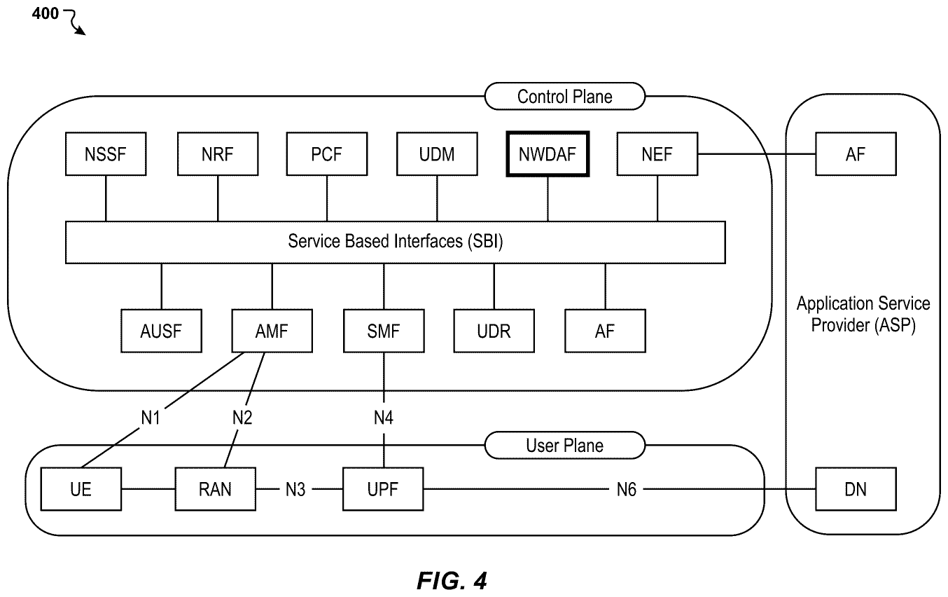

FIG. 4 illustrates an example network diagram 400, according to some implementations. The network diagram 400 includes a network slice selection function (NSSF), a network repository function (NRF), a policy control function (PCF), a unified data management (UDM) function, an NWDAF, a network exposure function (NEF), a service-based interface (SBI), an authentication server function (AUSF), an access and mobility function (AMF), a session management function (SMF), a unified data repository (UDR), an AF, an application service provider (ASP), a user plane function (UPF), a radio access network (RAN), and a UE. Additional details about the example network diagram 400 can be found in 3GPP, “System Architecture for the 5G System,” TS 23.501.

3GPP uses a 5G core network architecture as a service-based architecture (SBA). The architectural elements defined as network functions (NFs) provide services via interfaces of a common framework to any NFs that are allowed to access these services. NFs expose their own services and/or invoke services in other NFs via RESTful application programming interfaces (APIs) using a standard hypertext transfer protocol (HTTP)/2 routing mechanism over transmission control protocol (TCP).

To be discoverable to service consumers, service producers must register with an NRF. Upon request from an NF, the NRF responds with a list of identifiers for suitable service producers, which can fulfill the service criteria posed by the NF. The NF may, for example, request a list of all service producers.

An AF exposes the Application Layer for interaction with other 5G NFs and network resources, which allows applications to seamlessly communicate with 5G CN. An AF may be involved in policy control and session management, providing application services to subscribers. An AF can reside in the control plane of 5G SBA (trusted domain) or in an ASP external data network (DN) that communicates with other NFs over an NEF.

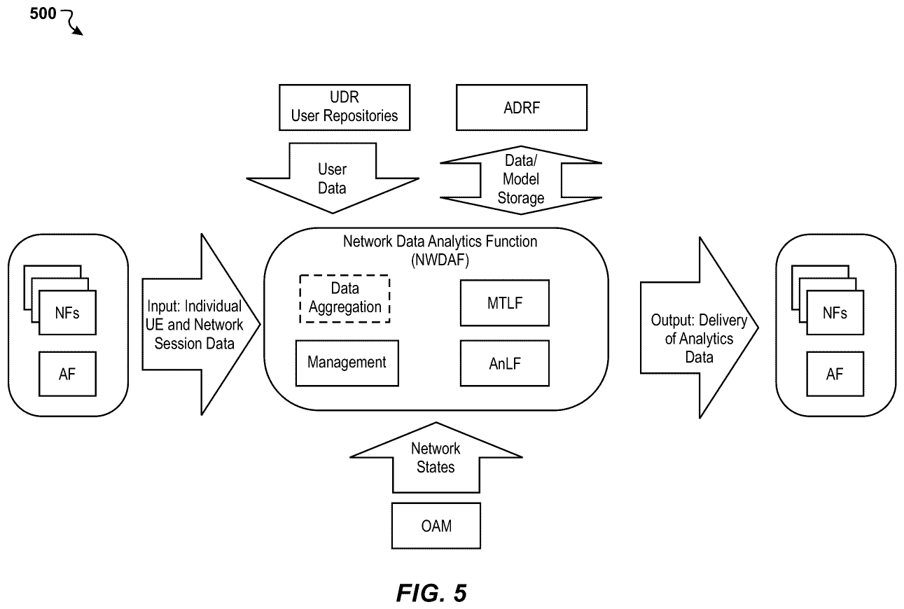

FIG. 5 illustrates an example network diagram 500, according to some implementations. The network diagram 500 may implement one or more aspects of the network diagram 400, as shown and described with reference to FIG. 4. For example, the network diagram 500 includes an NWDAF, NFs, and AFs, which may be examples of corresponding elements described with reference to FIG. 4. Additional details about the network diagram 500 can be found in 3GPP, “Architecture Enhancements for 5G System (5GS) to Support Network Data Analytics Services,” TS 23.288.

The NWDAF provides analytics to 5G Core NFs to enable autonomous network operations and service management, allowing for the integration of various data-driven AI/ML technologies into 5G networks. Acting as a service consumer, NWDAF can collect data (from NFs, AFs, and OAM) using SBI request/response data collection procedures. The NWDAF can then provide analytics (such as traffic load and resource utilization, network/service performance measurements, and user mobility pattern analysis) and predictions (for example, temporal/spatial traffic distribution prediction and UE location prediction) to UEs or other network entities.

However, there are some privacy concerns with the existing framework for 5G data collection and data analytics. In particular, the UE application shares individual data with AFs, which exposes them to network operators (the user has to consent). It may thus be desirable to integrate privacy-preserving data collection and learning mechanisms into the 3GPP architecture.

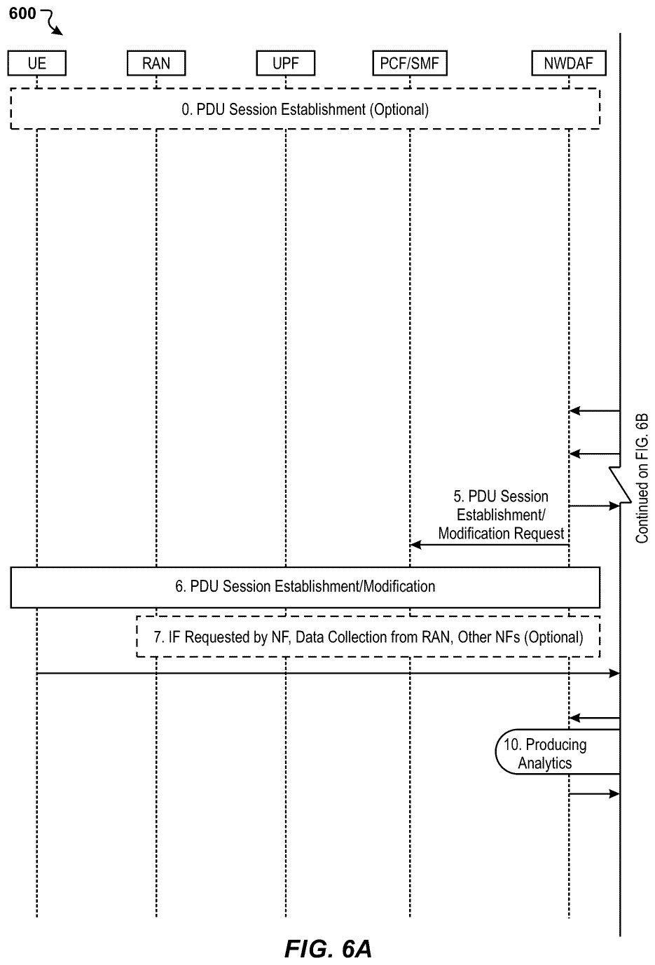

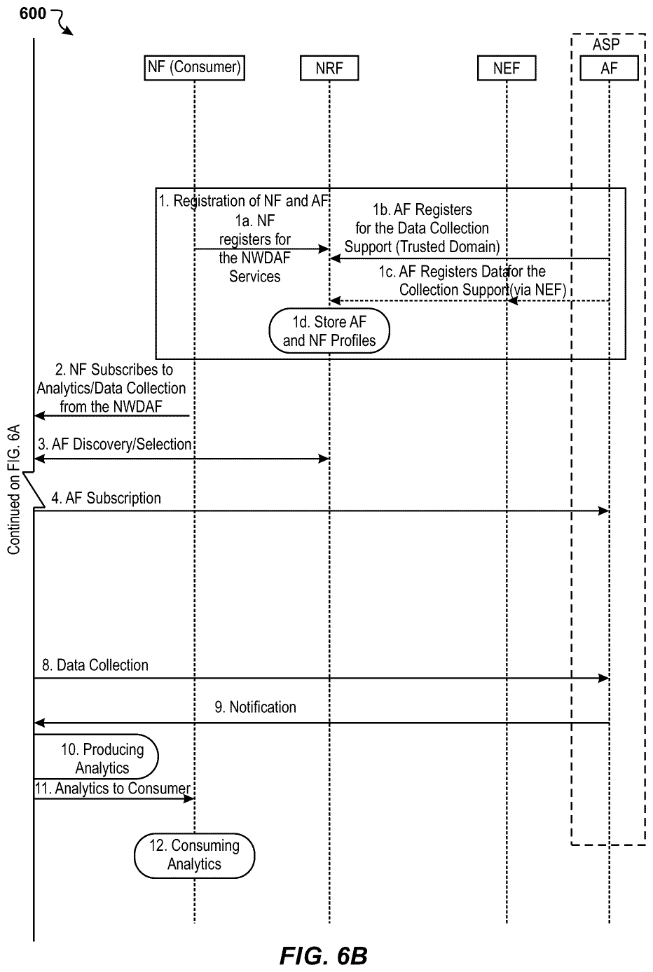

FIGS. 6A and 6B illustrate an example process flow 600, according to some implementations. The process flow 600 may implement one or more aspects of the network diagram 400, as shown and described with reference to FIG. 4. For example, the process flow 600 includes a UE, a RAN, a UPF, a PCF/SMF, an NWDAF, an NF (consumer), an NRF, an NEF, and an AF, which may be examples of corresponding elements described with reference to FIG. 4. Additional details about the network diagram 400 can be found in 3GPP, “Architecture Enhancements for 5G System (5GS) to Support Network Data Analytics Services,” TS 23.288.

In the example process flow 600, the UE may establish a PDU session with the NWDAF. The NF (consumer) may register for NWDAF services via the NRF. An AF may register for data collection support via a trusted domain or an NEF. The NRF may store the AF/NF profiles for later use. The NF (consumer) may subscribe to analytics/data collection from the NWDAF. The NWDAF may perform AF discovery/selection, for example, by retrieving the stored AF profile(s) from the NRF. The NWDAF may also subscribe to the AF.

The NWDAF may send a PDU session establishment/modification request to the PCF/SMF, which may trigger the requested PDU session establishment/modification. If requested by the NF, the NWDAF may collect data from the RAN and other NFs. This data may be collected by the AF, which may share the collected data with the NWDAF. Once received, the NWDAF may generate/produce analytics based on the collected data. The NWDAF may send the resulting analytics to the NF for consumption.

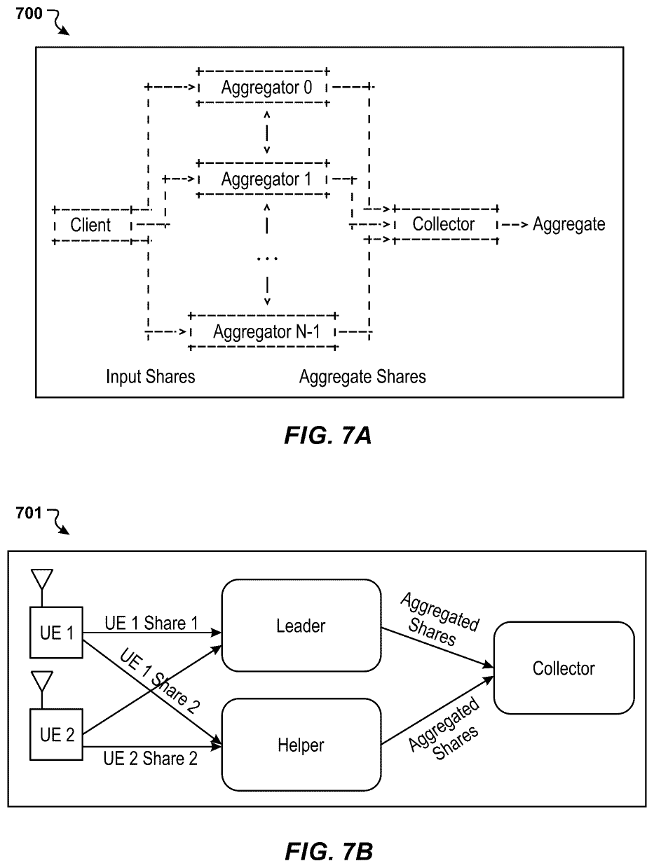

FIG. 7A illustrates an example data flow of a distributed aggregation function 700 (such as a VDAF), according to some implementations. As described herein, privacy-preserving data collection and learning can be achieved using VDAFs, which may utilize privacy-preserving cryptographic protocols, such as Prio. Additional details about VDAFs can be found in T. Geoghegan, et. al. “Distributed Aggregation Protocol for Privacy Preserving Measurement,” IETF. The Prio protocol involves several logical/architectural elements, including clients, aggregators, and collectors.

Clients (e.g., UEs) split their data into input shares and sending a single input share, along with a secret-shared non-interactive proof (SNIP), to each aggregator. Additional details about the Prio protocol and SNIP usage can be found in Corrigan-Gibbs, H., et al. “Prio: Private, Robust, and Scalable Computation of Aggregate Statistics,” NSDI. These shares are configured by an RNG, which helps to randomize the generation of shares, the number of shares, share size, etc. Aggregators (which include a Leader and a Helper) are responsible for UE data collection. Aggregators are responsible for converting/refining input shares to output shares. Aggregators can exchange information (e.g., SNIPs) among themselves as part of the validation process. Aggregators may be configured according to aggregation parameter (e.g., analytics type)

FIG. 7B illustrates an example aggregation system architecture 701 (such as a Prio-based aggregation system architecture), according to some implementations. The aggregation system architecture 701 may implement one or more aspects of the distributed aggregation function 700, as shown and described with reference to FIG. 7A. Additional details about the aggregation system architecture 701 can be found in U.S. patent application Ser. No. 18/506,243, entitled “SYSTEMS, METHODS, AND DEVICES FOR UE-ASSISTED PRIVACY-AWARE DATA-DRIVEN NW CONTROL,” filed Nov. 10, 2023, the entire contents of which are incorporated by reference herein.

In the example aggregation system architecture 701, the leader (main) is an aggregator responsible for coordinating data aggregation. The leader receives encrypted UE data and orchestrates the process of computing the aggregate result, as requested by the collector. The helper is an aggregator that assists the leader with computations. Privacy is preserved as long as the leader and the helper do not collide, e.g., as long as the leader and the helper do not contain the same data share. The collector is an entity that obtains aggregated output shares from the aggregators and combines them into the aggregated statistics. The physical realization of different Prio entities in a cellular network architecture can have different variants.

FIGS. 8A-8F illustrate an example process flow 800, according to some implementations. The process flow 800 may implement one or more aspects of the network diagram 400, as shown and described with reference to FIG. 4. For example, the process flow 800 includes a first UE (UE 1) a second UE (UE 2), a RAN, a UPF, a PCF/SMF, an NWDAF (e.g., collector), an NF (e.g., consumer), an NRF, a first AF (AF 1), a second AF (AF 2), and an NEF, which may be examples of corresponding elements described with reference to FIG. 4. The process flow 800 illustrates a privacy-preserving data aggregation scheme for privacy level 3 data inference.

The example process flow 800 illustrates a privacy-preserving data aggregation procedure that can be used for both data and model aggregation. In the example process flow 800, the aggregators may be implemented as AFs, and the collector may be implemented as the NWDAF. The NF (e.g., network coordination function) may request data collection from the NWDAF. As depicted in the example process flow 800, UE 1 and/or UE 2 may optionally establish a PDU session with the NWDAF. The NF and AFs (leader and helper) may register with the NRF. The NF can register characteristics for data collection/analytics (temporal/spatial scale).

AF 1 (the leader AF) can register for aggregation support via a trusted domain, for example, by specifying the type of data to collect and the supported aggregation type. AF 2 (the helper AF) can register for aggregation support via the NEF, for example, by specifying the type of data to collect and the supported aggregation type. The NRF may store the profiles of the NF (consumer), AF 1 (the leader), and AF 2 (the helper). The NF can then request data collection and analytics from the NWDAF. In response, the NWDAF may perform discovery of AFs from the NRF and select the leader/helper based on the NF request and AF characteristics.

In turn, the NWDAF subscribes to AF 1 (the leader) and AF 2 (the helper). Based on the selected AF and NF, the NWDAF sends a PDU session establishment/modification request to communicate secure aggregation parameters. This request may trigger an uplink PDU session establishment/modification. For privacy-preserving model aggregation, the NWDAF may initiate a downlink PDU session establishment/modification, retrieve the appropriate ML model from the ADRF, and send data associated with the ML model to UE 1 and/or UE 2.

If requested by the NF, the NWDAF can optionally collect data from the RAN and other NFs. For privacy-preserving model aggregation, the NWDAF may send data associated with the ML model to UE 1. In some implementations, the NWDAF may provide the data associated with the ML model by means of a non-access spectrum (NAS) message over the AMF. UE 1 may train or update the ML model using local UE data. UE 1 may be configured with RNG and SNIP parameters to use for data/model share creation and SNIP generation. The data/model shares may include data associated with the newly trained ML model or data inferred using the newly trained ML model.

UE 1 may send the data/model shares and corresponding SNIP proof to AF 1 (the leader) and AF 2 (the helper) during an uplink PDU session. In turn, AF 1 and AF 2 may exchange/validate the SNIP proofs to ensure the validity of the data/model shares. Once validated, AF 1 and AF 2 may create aggregate output shares from the input shares. AF 1 and AF 2 may then notify the NWDAF of the aggregate shares. The collector (e.g., the NWDAF) may collect the aggregate shares and calculate statistics (e.g., analytic data) or update the ML model based on the aggregated shares. For privacy-preserving model aggregation, the foregoing operations may be repeated as iterations in model training. Once complete, the NWDAF stores the trained/updated ML model in the ADRF.

In some implementations, the NWDAF provides the statistics/analytics derived from the collected data to the consumer NF, UE 1, and/or UE 2, which can use the statistics/analytics as needed. One or both AFs in the 5G core network can be replaced by another NWDAF (e.g., an aggregator NWDAF). The foregoing data aggregation process is privacy-preserving because the consumers (e.g., the NF) only receive statistics associated with the collected data without revealing or exposing the underlying data.

FIGS. 9A and 9B illustrate an example process flow 900, according to some implementations. The process flow 900 may implement one or more aspects of the network diagram 400, as shown and described with reference to FIG. 4. For example, the process flow 900 includes a UE, a RAN, a UPF, a PCF/SMF, an NWDAF, an ADRF, an NF (consumer), an NRF, an NEF, an AF, and an ASP, which may be examples of corresponding elements described with reference to FIG. 4. The process flow 900 illustrates a privacy-preserving data aggregation scheme for privacy level 0 data inference.

In the example process flow 900, the UE may establish a PDU session with the NWDAF. The NWDAF may obtain UE data privacy levels (as shown in Table 1) via the PDU session or by means of a NAS message over the AMF. The NRF may assist with registration of the NF and AF with the NWDAF. For example, the NF (consumer) may register for NWDAF services by specifying characteristics to use for data collection/analytics (such as temporal/spatial scale). The AF can register for data collection, training support, or analytics/learning services via a trusted domain or the NEF by specifying UE application characteristics (such as the type of data to collect). To complete the registration process, the NRF stores the AF/NF profiles.

The NF can initiate data collection and analytics from the NWDAF. The UE can also subscribe to analytics/learning from the NWDAF. The NWDAF can perform discovery of AFs from the NRF based on the NF request and AF UE characteristics. The NWDAF may also subscribe to the AF. Based on the selected AF and NF, the NWDAF may request PDU session establishment/modification. If requested by the NF, the NWDAF may collect data from the RAN and other NFs.

The NWDAF may retrieve an ML model from the ADRF and send the ML model to the UE by means of a downlink PDU session or a NAS message. After receiving the ML model, the UE may infer local data (privacy level 0) using the received model. Once complete, the UE can send the inferred data to the AF by means of an uplink PDU session or a NAS message. The AF can process the inferred data from multiple UEs according to various parameters (such as EventID or EventFilter). The AF may then notify the NWDAF of the processed data.

The NWDAF can process analytics and/or perform ML training using data received from the AF. The NWDAF may then store the updated/trained model in the ADRF and provide the analytics data and/or ML inference to the NF for consumption. Additionally, or alternatively, the NWDAF may transfer the model/analytics data to the UE via a downlink PDU session or a NAS message. The UE may then consume the model/analytics data as needed. The privacy-preserving data aggregation scheme depicted in the example process flow 900 allows the NF to obtain analytics without exposing the UE data to the network.

FIGS. 10A and 10B illustrate an example process flow 1000, according to some implementations. The process flow 1000 may implement one or more aspects of the network diagram 400, as shown and described with reference to FIG. 4. For example, the process flow 1000 includes a UE, a RAN, a UPF, a PCF/SMF, an NWDAF, an ADRF, an NF (consumer), an NRF, an NEF, an AF, and an ASP, which may be examples of corresponding elements described with reference to FIG. 4. The process flow 1000 illustrates a privacy-preserving data aggregation scheme for privacy level 1/2 data inference.

In the example process flow 1000, the UE may establish a PDU session with the NWDAF. The NWDAF may obtain UE data privacy levels (shown in Table 1) via the PDU session or by means of a NAS message over the AMF. The NRF may facilitate registration of the NF and AF with the NWDAF. The NF (consumer) can register for NWDAF services by specifying characteristics to use for data collection/analytics (such as temporal/spatial scale). The AF can register for data collection, training support, or analytics/learning services (via a trusted domain or the NEF) by specifying UE application characteristics (such as the type of data to collect). To complete the registration process, the NRF stores the AF/NF profiles.

The NF can initiate data collection and analytics from the NWDAF. The UE can also subscribe to analytics/learning from the NWDAF. The NWDAF can perform discovery of AFs from the NRF based on the NF request and AF UE characteristics. The NWDAF can also subscribe to the AF. Based on the selected AF and NF, the NWDAF may request PDU session establishment/modification. If requested by the NF, the NWDAF may also collect data from the RAN and/or other NFs.

For model training, the NWDAF retrieves an ML model from the ADRF and sends the ML model to the UE by means of a downlink PDU session or a NAS message. After receiving the ML model, the UE trains the ML model with local data. Once complete, the UE sends the data/model (privacy level 1 or 2) to the AF via an uplink PDU session or a NAS message. The AF can process the collected data from multiple UEs according to various parameters (such as EventID or EventFilter). The AF may then notify the NWDAF of the processed data.

The NWDAF can process analytics and/or perform ML training using the data/model received from the AF. For model training, the foregoing operations can be repeated as iterations in model training. Once training is complete, the NWDAF can store the updated/trained model in the ADRF and provide the analytics data and/or ML inference to the consumer NF. Additionally, or alternatively, the NWDAF may transfer the model/analytics data to the UE via a downlink PDU session or a NAS message. The UE may consume the model/analytics data as needed. In the example process flow 1000 depicted in FIGS. 10A and 10B, the UE data (privacy/sensitivity level 1 or 2) is shared with the network.

The example process flow 1000 illustrates coordination signaling and message flow for secure aggregation in 6G architecture by extending 3GPP network architecture to support privacy-preserving data collection and training. In some implementations, there are two UEs and two aggregators, where the NF registers with the NRF for data collection NWDAF service. Aggregators can be implemented as AFs, while the collector can be implemented in NWDAF as a service consumer. The leader (an aggregator in the network domain that is responsible for coordinating the data aggregation) and the helper (an aggregator in the ASP domain that assists the leader with the computation) can register with the NRF.

Based on AF configurations and available resources, the leader could reside in the ASP domain, while the helper could be implemented in the network domain (CN). The NF initiates data collection service from NWDAF. Based on the NF request for data collection service and registered AF characteristics, the NWDAF performs discovery of AFs from NRF and selects/subscribes to the leader and helper(s). Based on the selected AF and NF characteristics, the NWDAF requests for PDU session establishment or modification for UEs participating in data aggregation. Optionally, if requested by the NF, the NWDAF performs data collection from the RAN and other NFs. Based on the properties of the secure aggregation AFs, e.g., leader/helper configuration(s), UEs may create data shares and SNIPs that are used for validation of aggregators. The SNIPs are sent to the leader (AF1) and helper (AF2).

Privacy is preserved under the assumption that aggregators do not contain the same data share. Before creating aggregated shares, the leader (AF1) and helper (AF2) exchange and validate SNIP proofs to ensure validity of the data. The collector (NWDAF) collects aggregate shares and calculates aggregated statistics from the UE data. Finally, the NF consumes statistics of the collected data, without revealing UE privacy, e.g., without having direct access to private/sensitive data.

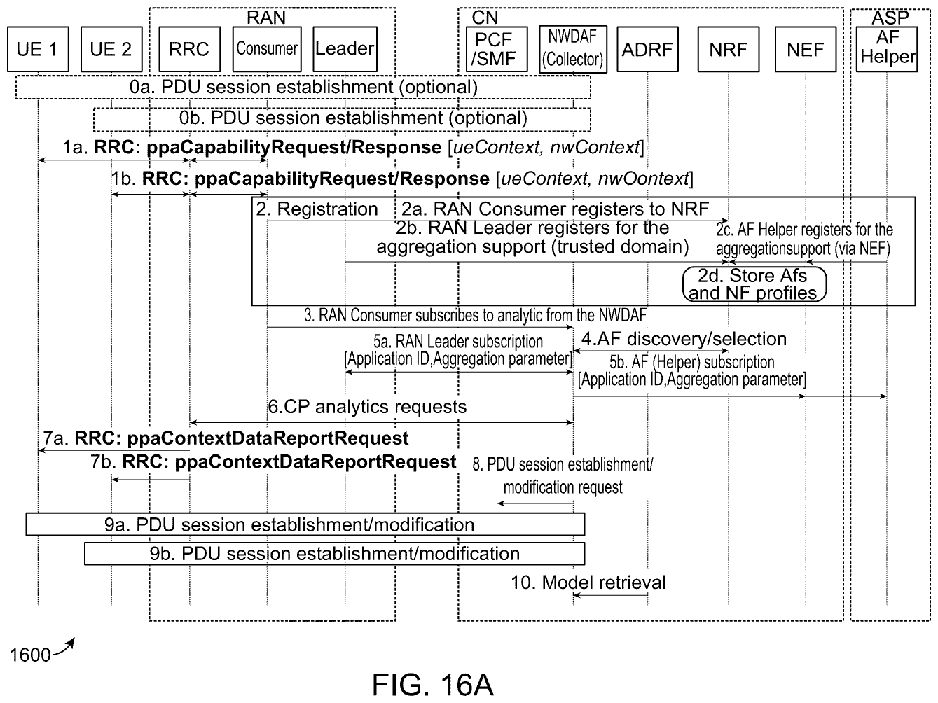

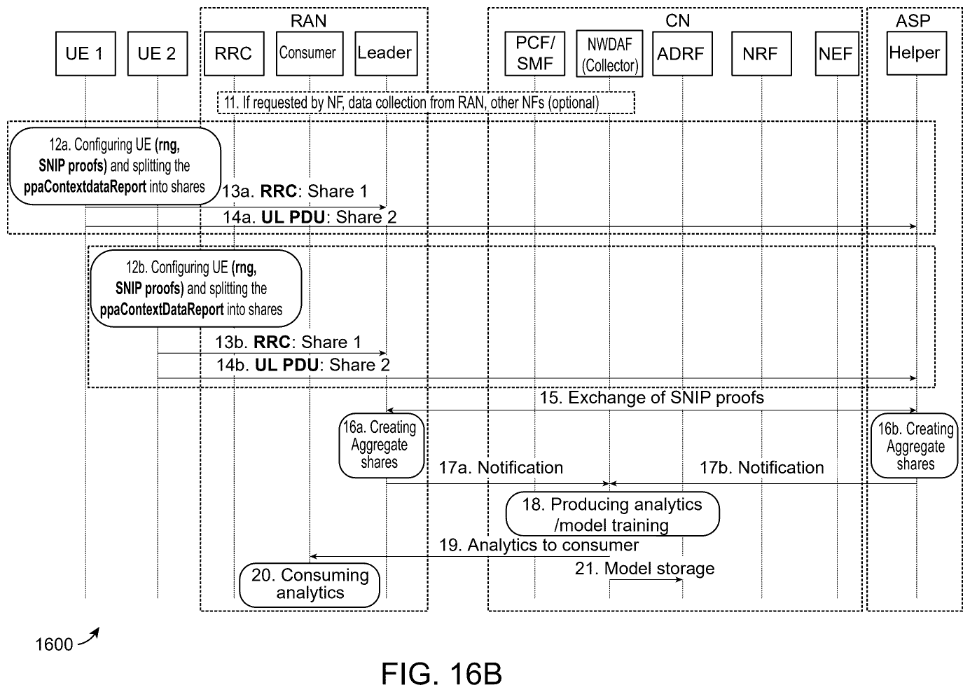

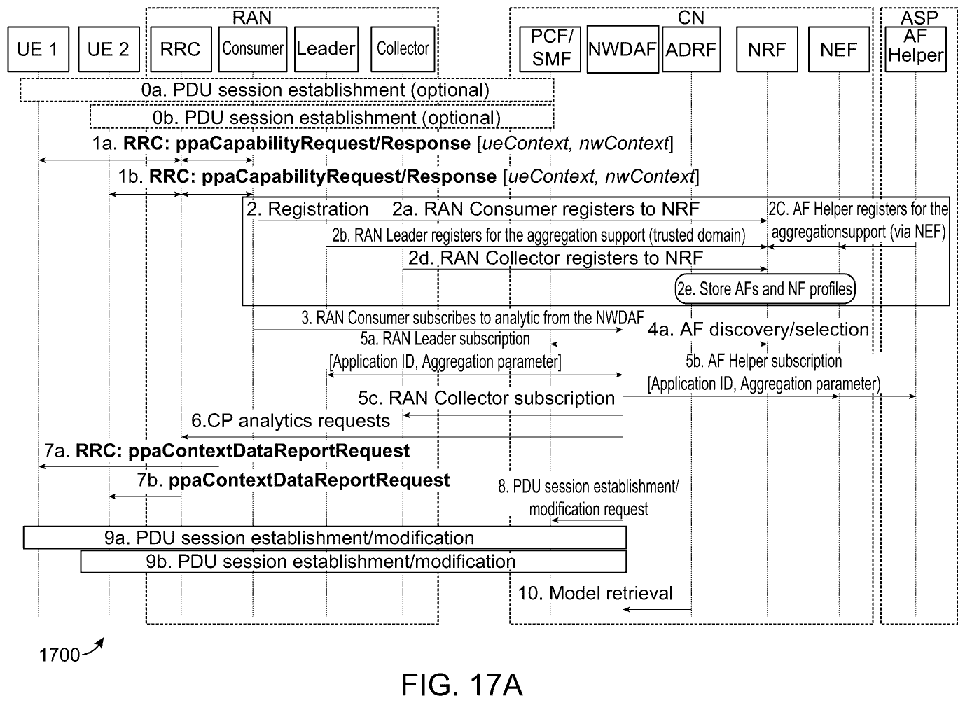

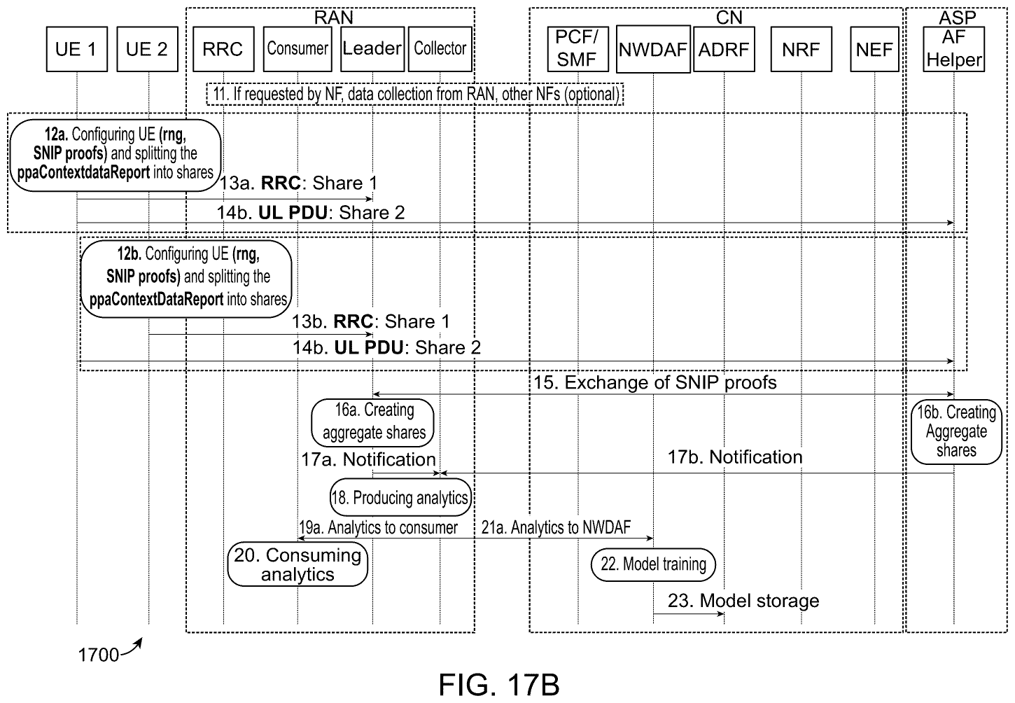

The data aggregation scheme depicted in FIGS. 10A and 10B assumes a CN deployment. The leader is deployed as an NF, while the helper is deployed in an ASP domain. The collector is deployed as an NWDAF, and the consumer is another NF. Clients are UEs connected to the network. This configuration can be extended to include further deployment options for different architectural nodes. For example, some implementations may leverage a RAN deployment where the NWDAF is the collector. This approach (which is shown in FIGS. 16A and 16B) can be used for passive analytics, where the NWDAF collects statistics on a larger time scale. In this example, the leader is deployed in the RAN, and the consumer is also deployed in RAN. The collector, helper and clients remain the same. Other implementations may leverage a RAN deployment where a RAN node serves as the collector. This approach (which is shown in FIGS. 17A and 17B) can be used for live analytics, where the RAN collects statistics on a smaller time scale. In this example, the leader, consumer, and the collector are all deployed in the RAN. The helper and clients remain the same.

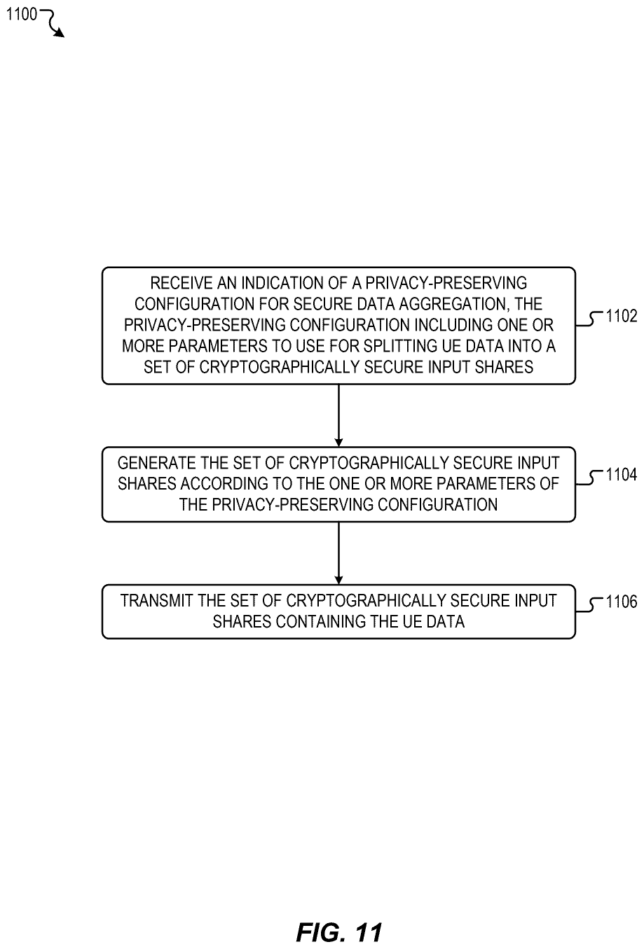

FIG. 11 illustrates a flowchart of an example method 1100, according to some implementations. For clarity of presentation, the description that follows generally describes the method 1100 in the context of the other figures in this description. For example, method 1100 can be performed by the UE 102 of FIG. 1. The method 1100 can be performed, for example, by any suitable system, environment, software, hardware, or a combination of systems, environments, software, and hardware, as appropriate.

In some implementations, various steps of the method 1100 can be run in parallel, in combination, in loops, or in any order. Additionally, or alternatively, the example method 1100 shown in FIG. 11 can be modified or reconfigured to include additional, fewer, or different steps (not shown in FIG. 11), which can be performed in the order shown or in a different order.

At 1102, the method 1100 includes receiving an indication of a privacy-preserving configuration for secure data aggregation, the privacy-preserving configuration including one or more parameters to use for splitting UE data into a set of cryptographically secure input shares.

At 1104, the method 1100 includes generating the set of cryptographically secure input shares according to the one or more parameters of the privacy-preserving configuration.

At 1106, the method 1100 includes transmitting the set of cryptographically secure input shares containing the UE data.

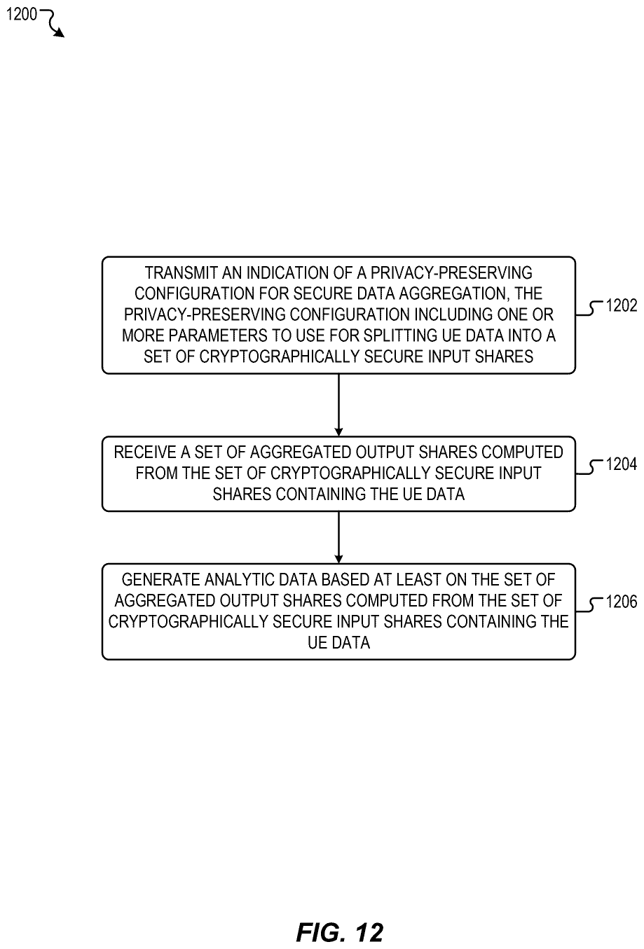

FIG. 12 illustrates a flowchart of an example method 1200, according to some implementations. For clarity of presentation, the description that follows generally describes method 1200 in the context of the other figures in this description. For example, method 1200 can be performed by the NWDAF depicted in FIG. 4. The method 1200 can be performed, for example, by any suitable system, environment, software, hardware, or a combination of systems, environments, software, and hardware, as appropriate.

In some implementations, various steps of the method 1200 can be run in parallel, in combination, in loops, or in any order. Additionally, or alternatively, the example method 1200 shown in FIG. 12 can be modified or reconfigured to include additional, fewer, or different steps (not shown in FIG. 12), which can be performed in the order shown or in a different order.

At 1202, the method 1200 includes transmitting an indication of a privacy-preserving configuration for secure data aggregation, the privacy-preserving configuration including one or more parameters to use for splitting UE data into a set of cryptographically secure input shares.

At 1204, the method 1200 includes receiving a set of aggregated output shares computed from the set of cryptographically secure input shares containing the UE data.

At 1206, the method 1200 includes generating analytic data based at least on the set of aggregated output shares computed from the set of cryptographically secure input shares containing the UE data.

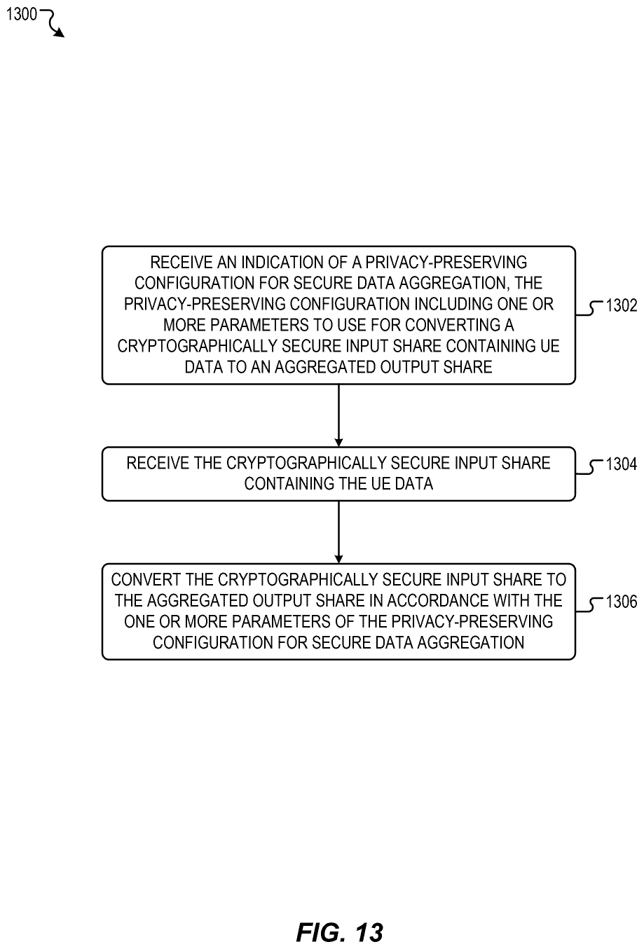

FIG. 13 illustrates a flowchart of an example method 1300, according to some implementations. For clarity of presentation, the description that follows generally describes method 1300 in the context of the other figures in this description. For example, method 1300 can be performed by the AF depicted in FIG. 4. The method 1300 can be performed, for example, by any suitable system, environment, software, hardware, or a combination of systems, environments, software, and hardware, as appropriate.

In some implementations, various steps of the method 1300 can be run in parallel, in combination, in loops, or in any order. Additionally, or alternatively, the example method 1300 shown in FIG. 13 can be modified or reconfigured to include additional, fewer, or different steps (not shown in FIG. 13), which can be performed in the order shown or in a different order.

At 1302, the method 1300 includes receiving an indication of a privacy-preserving configuration for secure data aggregation, the privacy-preserving configuration including one or more parameters to use for converting a cryptographically secure input share containing UE data to an aggregated output share.

At 1304, the method 1300 includes receiving the cryptographically secure input share containing the UE data.

At 1306, the method 1300 includes converting the cryptographically secure input share to the aggregated output share in accordance with the one or more parameters of the privacy-preserving configuration for secure data aggregation.

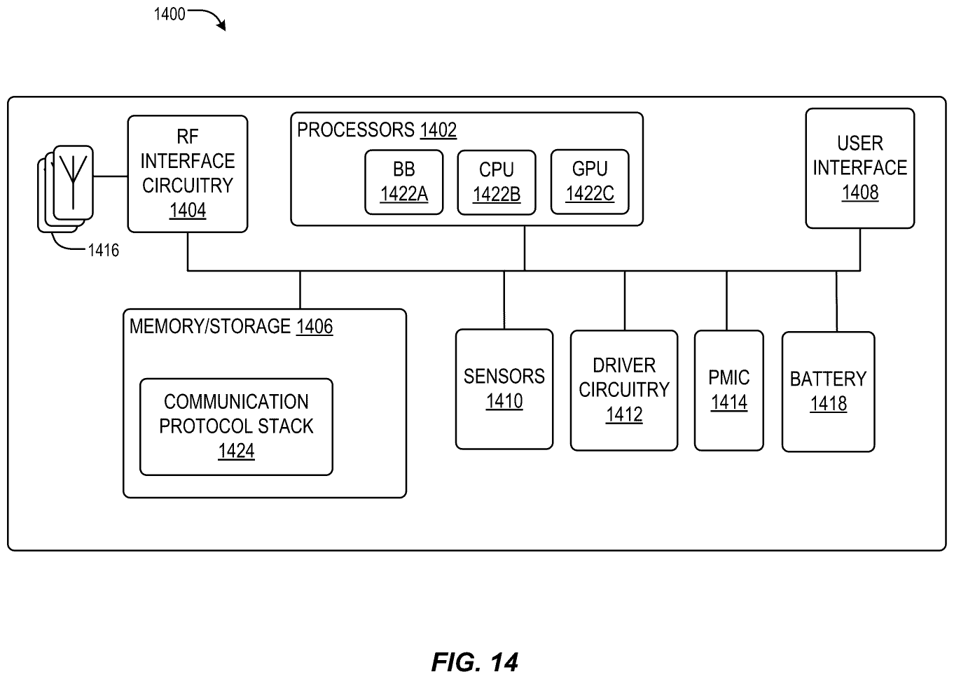

FIG. 14 illustrates an example UE 1400. The UE 1400 may be similar to and/or substantially interchangeable with UE 102 of FIG. 1.

The UE 1400 may be any mobile or non-mobile computing device, such as, for example, a mobile phone, computer, tablet, industrial wireless sensors, video device (for example, cameras, video cameras, etc.), wearable devices (for example, a smart watch), relaxed-IoT devices, etc.

The UE 1400 may include any/all of processor 1402, RF interface circuitry 1404, memory/storage 1406, user interface 1408, sensors 1410, driver circuitry 1412, power management integrated circuit (PMIC) 1414, one or more antenna(s) 1416, and battery 1418. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and a different arrangement of the components shown may occur in other implementations.

The components of the UE 1400 may be coupled with various other components over one or more interconnects 1420, which may represent any type of interface, input/output, bus (local, system, or expansion), transmission line, trace, optical connection, etc., that allows various circuit components (on common or different chips or chipsets) to interact with one another.

The processor 1402 may include one or more processors. For example, the processor 1402 may include processor circuitry such as, for example, baseband processor circuitry (BB) 1422A, central processor unit circuitry (CPU) 1422B, and graphics processor unit circuitry (GPU) 1422C. The processor 1402 may include any type of circuitry or processor circuitry that executes or otherwise operates computer-executable instructions, such as program code, software modules, or functional processes from memory/storage 1406 to cause the UE 1400 to perform operations as described herein.

In some implementations, the baseband processor circuitry 1422A may access a communication protocol stack 1424 in the memory/storage 1406 to communicate over a 3GPP compatible network. In general, the baseband processor circuitry 1422A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1404. The baseband processor circuitry 1422A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1406 may include one or more non-transitory, computer-readable media that includes instructions (for example, communication protocol stack 1424) that may be executed by the processor 1402 to cause the UE 1400 to perform various operations described herein. The memory/storage 1406 include any type of volatile or non-volatile memory that may be distributed throughout the UE 1400. In some implementations, some of the memory/storage 1406 may be located on the processor 1402 itself (for example, L1 and L2 cache), while other memory/storage 1406 is external to the processor 1402 but accessible thereto via a memory interface. The memory/storage 1406 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1404 may include transceiver circuitry and radio frequency front module (RFEM) that allows the UE 1400 to communicate with other devices over a radio access network. The RF interface circuitry 1404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1416 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1416. In various implementations, the RF interface circuitry 1404 may be configured to transmit/receive signals in a manner compatible with NR access technologies.

The antenna(s) 1416 may include one or more antenna elements to convert electrical signals into radio waves to travel through the air and to convert received radio waves over the air into electrical signals. In some implementations, the antenna elements may be arranged into one or more antenna panels. The antenna(s) 1416 may have antenna panels that are omnidirectional, directional, or a combination thereof, to enable beamforming and multiple input, multiple output communications. The antenna(s) 1416 may include any/all of microstrip antennas, printed antennas fabricated on the surface of one or more printed circuit boards, patch antennas, phased array antennas, etc. The antenna(s) 1416 may have one or more panels designed for one or more specific frequency bands, such as bands in FR1 or FR2.

The user interface 1408 includes various input/output (I/O) devices designed to enable user interaction with the UE 1400. The user interface 1408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1400.

The sensors 1410 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1412 may include software and hardware elements that operate to control particular devices that are embedded in the UE 1400, attached to the UE 1400, or otherwise communicatively coupled with the UE 1400. The driver circuitry 1412 may include individual drivers allowing other components to interact with or control various input/output (I/O) devices that may be present within, or connected to, the UE 1400. For example, driver circuitry 1412 may include a display driver to control and allow access to a display device, a touchscreen driver to control and allow access to a touchscreen interface, sensor drivers to obtain sensor readings of sensors 1410 and control and allow access to sensors 1410, drivers to obtain actuator positions of electro-mechanic components or control and allow access to the electro-mechanic components, a camera driver to control and allow access to an embedded image capture device, audio drivers to control and allow access to one or more audio devices.

The PMIC 1414 may manage power provided to various components of the UE 1400. In particular, with respect to the processor 1402, the PMIC 1414 may control power-source selection, voltage scaling, battery charging, or DC-to-DC conversion.

In some implementations, the PMIC 1414 may control, or otherwise be part of, various power saving mechanisms of the UE 1400. A battery 1418 may power the UE 1400, although in some examples the UE 1400 may be mounted deployed in a fixed location, and may have a power supply coupled to an electrical grid. The battery 1418 may be a lithium ion battery, a metal-air battery, such as a zinc-air battery, an aluminum-air battery, a lithium-air battery, and the like. In some implementations, such as in vehicle-based applications, the battery 1418 may be a typical lead-acid automotive battery.

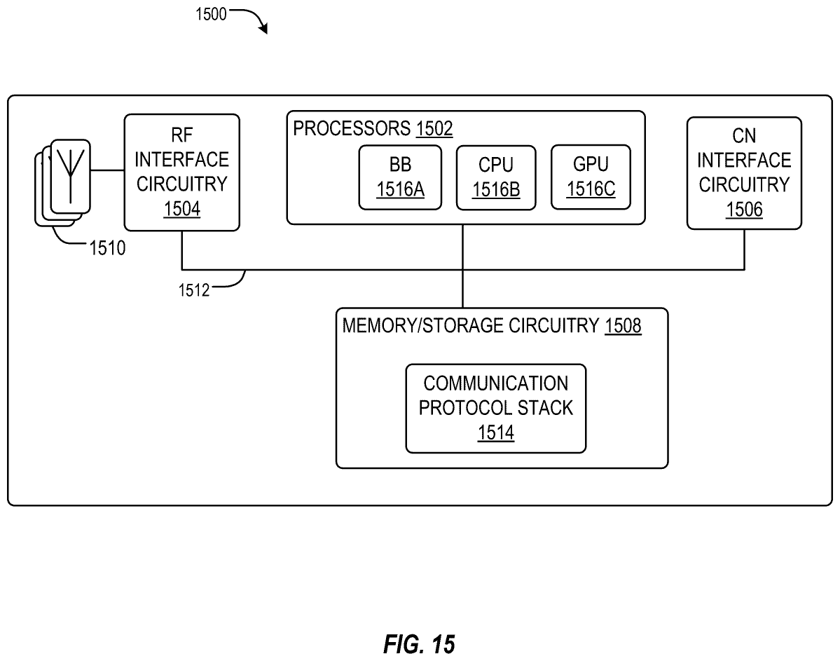

FIG. 15 illustrates an example access node 1500 (e.g., a base station or gNB), according to some implementations. The access node 1500 may be similar to and substantially interchangeable with base station 104. The access node 1500 may include one or more of processor 1502, RF interface circuitry 1504, core network (CN) interface circuitry 1506, memory/storage circuitry 1508, and one or more antenna(s) 1510. The processor 1502 may include any type of circuitry or processor circuitry that executes or otherwise operates computer-executable instructions, such as program code, software modules, or functional processes from memory/storage circuitry 1508 to cause the access node 1500 to perform operations as described herein.

The components of the access node 1500 may be coupled with various other components over one or more interconnects 1512. The processor 1502, RF interface circuitry 1504, memory/storage circuitry 1508 (including communication protocol stack 1514), antenna(s) 1510, and interconnects 1512 may be similar to like-named elements shown and described with respect to FIG. 14. For example, the processor 1502 may include processor circuitry such as, for example, baseband processor circuitry (BB) 1516A, central processor unit circuitry (CPU) 1516B, and graphics processor unit circuitry (GPU) 1516C.

The CN interface circuitry 1506 may provide connectivity to a core network, for example, a 5th Generation Core network (5GC) using a 5GC-compatible network interface protocol such as carrier Ethernet protocols, or some other suitable protocol. Network connectivity may be provided to/from the access node 1500 via a fiber optic or wireless backhaul. The CN interface circuitry 1506 may include one or more dedicated processors or FPGAs to communicate using one or more of the aforementioned protocols. In some implementations, the CN interface circuitry 1506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1500 that operates in an NR or 5G system (for example, a gNB), and the term “E-UTRAN node” or the like may refer to an access node 1500 that operates in an LTE or 4G system (e.g., an eNB). According to various implementations, the access node 1500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1500 may be implemented as one or more software entities running on server computers as part of a virtual network, which may be referred to as a CRAN and/or a virtual baseband unit pool (vBBUP). In V2X scenarios, the access node 1500 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

FIGS. 16A and 16B illustrate an example process flow 1600, according to some implementations. The process flow 1600 can be implemented by one or more aspects of the network diagram 400, as shown and described with reference to FIG. 4. For example, some operations of the process flow 1600 can be performed by a first UE (UE 1), a second UE (UE 2), a RAN (including an RRC layer, a consumer node, and a leader node), a CN (including a PCF/SMF, an NWDAF, an ADRF, an NRF, and an NEF), and an ASP (including an AF helper). In the example process flow 1600 of FIG. 16, the NWDAF serves as the collector for privacy-aware data aggregation.

The process flow 1600 illustrates a privacy-preserving data aggregation procedure where the NWDAF is the collector, the RAN is the leader, AFs are helpers, and consumers (e.g., network coordination functions) residing in the RAN can request data collection services. In the process flow 1600, a PDU session is optionally established between the UEs and the CN. The RAN may send a query for UE aggregation capabilities (e.g., the aggregContextCapabilityRequest IE) and receive the requested aggregation capability information (e.g., via the aggregContextCapabilityResponse IE). The consumer, leader, and helpers may register with the NRF via the NEF. The consumer may register characteristics of data collection/analytics, e.g., temporal/spatial scale, contextual data type, etc. The leader and helper(s) may register their contextual data type and supported aggregation type. The NRF may store the profiles of the consumers and aggregators.

The consumer(s) may initiate data collection and analytics from the NWDAF, which performs discovery of AFs from the NRF based on the NF request and AF characteristics. The NWDAF may also select the leader/helper and subscribe to the aggregators. The NWDAF may send an analytics request, via control plane (CP), by sending an RRC message (e.g., with the aggregContextReportRequest IE) indicating which UE and network context to collect, as well as the aggregators and destinations. Based on the selected aggregators and consumers, the NWDAF may request uplink PDU session establishment or modification (e.g., to communicate secure aggregation parameters). In some implementations, the NWDAF may retrieve model information from the ADRF, such that the NWDAF (e.g., the collector) can train the model on the collected aggregated data.

If requested by the NF, data can be collected from the RAN and other NFs. The RNG may configure the UEs to create data/shares and generate SNIP proofs. The UEs can send a first data share and a corresponding SNIP proof to the leader (in the RAN) via an RRC message. The UEs can send a second data share and corresponding SNIP proof to the helper (AF) via the uplink PDU session. The leader and helper can exchange/validate proofs to ensure the validity of the data. Once validated, the leader and helper can create aggregate shares. The collector (NWDAF) may collect the aggregate shares, calculate statistic/analytic data, and optionally train the model retrieved from the ADRF. The NWDAF can provide the statistics associated with the collected data to the consumer node in the RAN. The consumer can then use the statistics/analytics for various purposes. In some implementations, the NWDAF may store the trained model in the ADRF. The data aggregation scheme depicted in FIGS. 16A and 16B supports privacy preservation because the consumer (in the RAN) obtains statistic/analytic data from the collected UE data without exposing the actual UE data itself.

To support the privacy-preserving data aggregation procedure shown in FIGS. 16A and 16B, the UEs may be configured to provide the RAN with connectivity contextual information via RRC signaling. Each UE connected to the network may have a collection of data that can provide useful information (e.g., location information, application type, number of applications.) for optimizing different network procedures (e.g., mobility, network load). Sharing this information, however, should be done in a privacy-preserving manner. Aggregated statistical information derived from this data (not the data itself) can be used for various purposes.

This contextual data can be shared with the RAN through the privacy-preserving data aggregation framework described herein. This framework allows the RAN to correlate different configurations, contextual features, key performance indicators (KPIs), and learnt histograms. The specific content of the contextual data can be negotiated by the UE and the network. The contextual data can have different levels of granularity, which may be associated with different privacy/sensitivity levels. For example, a lower granularity may be associated with a low privacy/sensitivity, a high granularity may be associated with a high privacy/sensitivity, etc. Similarly, contextual data can be associated with different privacy-preserving techniques, e.g., to use Prio (isPrioReq) with or without differential privacy (isDpReq) with varying noise levels (epsilon).

Differential privacy generally refers to the process of adding noise (e.g., flipped bits or padding bits) to private or sensitive data, thereby providing an additional layer of data obfuscation/protection. For example, if there are a hundred bits of actual data, the UE can introduce some degree of error (e.g., noise) by flipping the value of two or three bits. Introducing noise in this way can help prevent actual data from being exposed/compromised. Aggregated statistics can still be derived from the resulting data, even with some degree of noise. The amount of added noise can be controlled by adjusting the differential privacy level. In other words, the differential privacy level defines the noise variance of the actual data.

As an example, the contextual data can include UE contextual data (e.g., location information, application type, number of applications), network contextual data (e.g., network measurements of RSRP, RSRQ and/or SINR), network configurations (e.g., frequency band, beam index, number of layers). The RAN can query UE and network contextual data by sending a request and collecting privacy-preserving aggregate statistics of such information. The UE can optionally use differential privacy when sending data shares to different aggregators (e.g., leader and helper). The UE may inform the RAN of which noise level it will use via the UE capability information.

In some implementations, the capability information can be exchanged via RRC messages. For example, the RAN may send a PPA capability request message to all UEs to inquire about the contextual data that is available for aggregation (along with other parameters). The UEs can transmit a PPA capability response message to identify which contextual data can be shared with the RAN through PPA (along with other parameters). One possible implementation of the PPA capability request/response message is listed below:

| ppaCapabilityReq ::= | | | | | SEQUENCE { | | | | |
|---|---|---|---|---|---|---|---|---|---|
| nwContext | ENUMERATED {true} | | | | | | | OPTIONAL, | |
| ueContext | ENUMERATED {true} | | | | | | | OPTIONAL | |
| } | | | | | | | | | |
| ppaCapabilityResponse ::= | | | | | | | SEQUENCE { | | |
| nwContext | SEQUENCE { | | | | | | | | |
| measurement | | | | CHOICE { | | | | | |
| RSRP | | | | RSRP-Range, | | | | | |
| RSRQ | | | | RSRP-Range, | | | | | |
| SINR | | | | RSRP-Range | | | | | |
| } SEQUENCE { | | | | OPTIONAL, | | | | | |
| granularity | | ENUMARATED {1,2,3,4,5,6} | | | | | | | |
| isPrioReq | | | ENUMERATED {true, false} | | | | | | |
| isDpReq | | | ENUMERATED {true, false} | | | | | | |
| epsilon | | ENUMERATED {1e−2, 1e−1,0,1, ..., 5}} | | | | | | | |
| } | | | | | OPTIONAL, | | | | |
| band Band | | | | | | | OPTIONAL, | | |
| rat ENUMERATED {4g, 5g, 6g} | | | | | | | | | OPTIONAL, |
| } | | | | | | OPTIONAL, | | | |
| ueContext | SEQUENCE { | | | | | | | | |
| location | | SEQUENCE { | | | | | | OPTIONAL, | |
| granularity level. | | | ENUMARATED {1, 2,3,4,5,6} | | | | | | |
| isPrioReq | | | ENUMERATED {true, false} | | | | | | |
| isDpReq | | | ENUMERATED {true, false} | | | | | | |
| epsilon | | ENUMERATED {none, 1e−2, 1e−1,0,1, ..., 5}} | | | | | | | |
| } | | | | | | | | | |

Based on the capability information, the RAN can send a PPA contextual data report request message containing specific fields that indicate which of the available/supported UE contextual data should be sent as part of the contextual data report. The PPA contextual data report request message can also inform the UE of which aggregation nodes the report should be sent to (e.g., RAN, CN, ASP or edge node). The PPA contextual data report contains the actual data share that is sent to the aggregation node. If the aggregation node is deployed in the RAN, the PPA contextual data report can be sent as an RRC message. If the aggregation node is deployed in ASP, the PPA contextual data report can be sent via an established PDU session. If the aggregation node is deployed in the CN, the PPA contextual data report can be sent as a NAS message. One possible implementation of the PPA contextual data report request and PPA contextual data report is listed below:

| ppaContextDataReportReq ::= | | | | | | | | | | SEQUENCE { | | | |
|---|---|---|---|---|---|---|---|---|---|---|---|---|---|
| nwContext | | SEQUENCE { | | | | | | | | | | | |
| measurement | | | | | | CHOICE { | | | | | | | |
| RSRP | | | | | | RSRP-Range, | | | | | | | |
| RSRQ | | | | | | RSRP-Range, | | | | | | | |
| SINR | | | | | | RSRP-Range | | | | | | | |
| } | | | | | | | | | | | | | |
| granularity 3 | | | | | | | | | | | | | |
| isPrioReq | | | | | true | | | | | | | | |
| isDpReq | | | | | true | | | | | | | | |
| | | | | | | | OPTIONAL, | | | | | | |
| band | Band | | | | | | | | OPTIONAL, | | | | |
| granularity 4 | | | | | | | | | | | | | |
| isPrioReq | | | | | true | | | | | | | | |
| isDpReq | | | | | false | | | | | | | | |
| rat | ENUMERATED {4g, 5g, 6g} | | | | | | | | | | | OPTIONAL, | |
| } | | | | | | | | OPTIONAL, | | | | | |
| ueContext | | SEQUENCE { | | | | | | | | | | | |
| location | | | | | | | OPTIONAL | | | | | | |
| granularity 1 | | | | | | | | | | | | | |
| isPrioReq | | | | | true | | | | | | | | |
| isDpReq | | | | | true | | | | | | | | |
| } | | | | | | | | | | | | | |
| ppaContextDataReport::= | | | | | | | | | SEQUENCE { | | | | |
| SNIP | | | | | | | | | | | | | |
| nwContextShare | | | | SEQUENCE { | | | | | | | | | |
| measurementShare | | | | | | | CHOICE { | | | | | | |
| RSRP-Share | | | | | | | RSRP-Range-Share, | | | | | | |
| RSRQ-Share | | | | | | | RSRQ-Range-Share, | | | | | | |
| SINR-Share | | | | | | | SINR-Range-Share, | | | | | | |
| } | | | | | | | | OPTIONAL, | | | | | |
| band-Share | | | Band | | | | | | | | OPTIONAL, | | |
| rat-Share | | | ENUMERATED {4g, 5g, 6g} | | | | | | | | | | OPTIONAL, |
| } | | | | | | | | OPTIONAL, | | | | | |
| ueContextShare | | | | SEQUENCE { | | | | | | | | | |
| location-Share | | | | | | | | | | | | | |
| } | | | | | | | | | | | | | |

FIGS. 17A and 17B illustrate an example process flow 1700, according to some implementations. The process flow 1700 may be implemented by one or more aspects of the network diagram 400, as shown and described with reference to FIG. 4. For example, some operations of the process flow 1700 can be performed by a first UE (UE 1), a second UE (UE 2), a RAN node (including an RRC layer, a consumer node, a leader node, and a collector node), a CN (including a PCF/SMF, an NWDAF, an ADRF, an NRF, and an NEF), and an ASP (including an AF helper). In the example process flow 1700 of FIG. 17, the RAN node serves as the collector for privacy-aware data aggregation.

The process flow 1700 illustrates a privacy-preserving data aggregation procedure where the collector, aggregator, and leader are all implemented in the RAN, the helper(s) are implemented as AFs, and the consumer (e.g., network coordination function), which resides in the RAN, can request data collection services. In the process flow 1700, a PDU session is optionally established between the UEs and the CN. The RAN may send a query for UE aggregation capabilities (e.g., the aggregContextCapabilityRequest IE) and receive the requested aggregation capability information (e.g., via the aggregContextCapability IE). The collector, consumer, leader, and helpers may register with the NRF via the NEF. The consumer may register characteristics of data collection/analytics, e.g., temporal/spatial scale, contextual data type, etc. The leader, collector, and helper(s) may register their contextual data type and supported aggregation type. The NRF may store the profiles of the consumers, aggregators, and the collector.

The consumer(s) may initiate data collection and analytics from the NWDAF, which performs discovery of AFs from the NRF based on the NF request and AF characteristics. The NWDAF may also select the leader/helper and subscribe to the aggregators as well as the collector. The NWDAF may send an analytics request, via a control plane (CP), by sending an RRC message (e.g., with the aggregContextReportRequest IE) indicating which UE and network context to collect, as well as the aggregators and destinations. Based on the selected aggregators and consumers, the NWDAF may request uplink PDU session establishment or modification (e.g., to communicate secure aggregation parameters). In some implementations, the NWDAF may retrieve model information from the ADRF. The NWDAF (e.g., the collector) may train the model on the aggregated data obtained by the collector.

If requested by the NF, data can be collected from the RAN and other NFs. The RNG may configure the UEs to create data/shares and generate SNIP proofs. The UEs can send a first data share and a corresponding SNIP proof to the leader (in the RAN) via an RRC message. The UEs can send a second data share and corresponding SNIP proof to the helper (AF) via the uplink PDU session. The leader and helper can exchange/validate proofs to ensure the validity of the data. Once validated, the leader and helper can create aggregate shares. The collector (NWDAF) may collect the aggregate shares, calculate statistic/analytic data based on the aggregated data, and provide the statistic/analytic data to the consumer node in the RAN. The consumer can then use the statistics/analytic data for various purposes.

In some implementations, the NWDAF may obtain aggregate statistics from the collector in the RAN. Additionally, or alternatively, the NWDAF can train the model (obtained from the ADRF) using aggregated statistics obtained from the collector. The NWDAF can then store the trained model in the ADRF. The data aggregation scheme depicted in FIG. 17 supports privacy preservation because the consumer (in the RAN) obtains statistic/analytic data from the collected UE data without exposing the actual UE data.

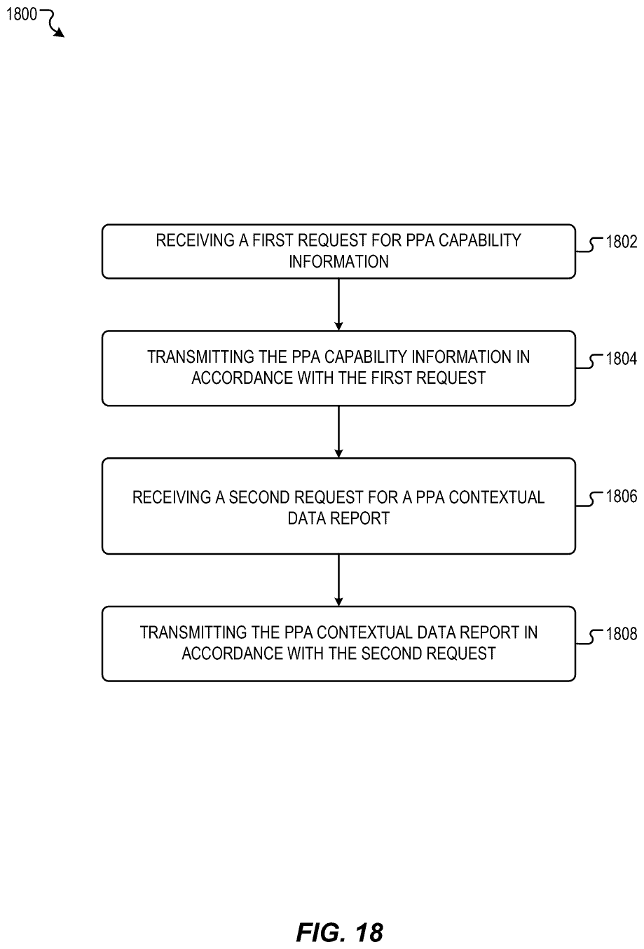

FIG. 18 illustrates a flowchart of an example method 1800, according to some implementations. For clarity of presentation, the method 1800 is described in the context of the preceding figures. For example, the method 1800 can be performed by the UE 102 of FIG. 1, or any suitable system, environment, software, hardware, or combination thereof. In some implementations, operations of the method 1800 can be run in parallel, in combination, in loops, or in any order. The example method 1800 shown in FIG. 18 can be modified or reconfigured to include additional, fewer, or different steps (not shown in FIG. 18), which can be performed in the order shown or in a different order.

At 1802, the method 1800 includes receiving a first request for PPA capability information.

At 1804, the method 1800 includes transmitting the PPA capability information in accordance with the first request.

At 1806, the method 1800 includes receiving a second request for a PPA contextual data report.

At 1808, the method 1800 includes transmitting the PPA contextual data report in accordance with the second request.

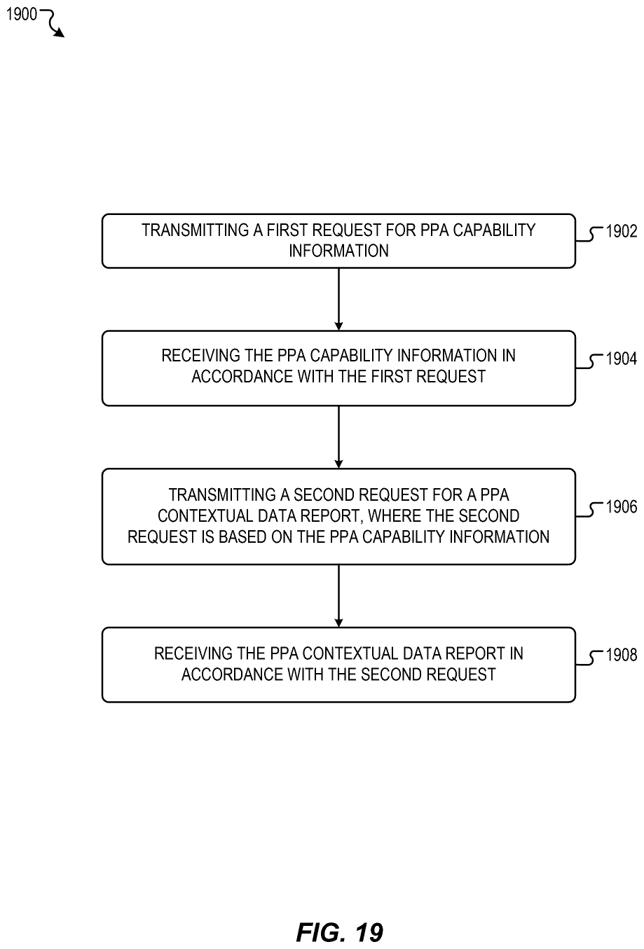

FIG. 19 illustrates a flowchart of an example method 1900, according to some implementations. For clarity of presentation, the method 1900 is described in the context of the preceding figures. For example, the method 1900 can be performed by the base station 104 of FIG. 1, or any suitable system, environment, software, hardware, or combination thereof. In some implementations, operations of the method 1900 can be run in parallel, in combination, in loops, or in any order. The example method 1900 shown in FIG. 19 can be modified or reconfigured to include additional, fewer, or different steps (not shown in FIG. 19), which can be performed in the order shown or in a different order.

At 1902, the method 1900 includes transmitting a first request for PPA capability information.

At 1904, the method 1900 includes receiving the PPA capability information in accordance with the first request.

At 1906, the method 1900 includes transmitting a second request for a PPA contextual data report, where the second request is based on the PPA capability information.

At 1908, the method 1900 includes receiving the PPA contextual data report in accordance with the second request.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below.

Example 1 includes one or more processors configured to, when executing instructions stored in a memory, perform operations including: receiving, via RF circuitry, a first request for PPA capability information; instructing the RF circuitry to transmit the PPA capability information in accordance with the first request; receiving, via the RF circuitry, a second request for a PPA contextual data report; and instructing the RF circuitry to transmit the PPA contextual data report in accordance with the second request.

Example 2 includes the one or more processors of example 1, where the PPA capability information indicates a capability to provide at least one of network context information or UE context information.

Example 3 includes the one or more processors of example 2, where the network context information includes one or more network measurements that include at least one of RSRP, RSRQ, or SINR.

Example 4 includes the one or more processors of example 3, where the PPA contextual data report includes one or more cryptographically secure input shares containing data associated with the one or more network measurements.

Example 5 includes the one or more processors of any of examples 2 to 4, where the network context information includes one or more network configuration parameters that include at least one of a frequency band, a RAT, a beam index, or a number of layers.

Example 6 includes the one or more processors of example 5, where the PPA contextual data report includes one or more cryptographically secure input shares containing data associated with the one or more network configuration parameters.

Example 7 includes the one or more processors of any of examples 2 to 6, where the UE context information includes at least one of UE location information or UE application status information.

Example 8 includes the one or more processors of example 7, where the PPA contextual data report includes one or more cryptographically secure input shares containing data associated with the UE location information or the UE application status information.

Example 9 includes the one or more processors of any of examples 2 to 8, where the PPA capability information includes at least one of a granularity level, a cryptographic protocol, a differential privacy scheme, or a noise level to use for PPA of the network context information or the UE context information.

Example 10 includes the one or more processors of any of examples 2 to 9, where the second request for the PPA contextual data report includes a request for at least some of the network context information or the UE context information.

Example 11 includes the one or more processors of any of examples 2 to 10, where the second request for the PPA contextual data report indicates at least one of a granularity level, a cryptographic protocol, a differential privacy scheme, or a noise level to use for PPA of the network context information or the UE context information.

Example 12 includes the one or more processors of any of examples 1 to 11, where transmitting the PPA contextual data report in accordance with the second request includes transmitting the PPA contextual data report to one or more aggregation nodes identified by the second request.

Example 13 includes the one or more processors of example 12, where the one or more aggregation nodes include at least one of a RAN node, a CN node, or an ASP node.

Example 14 includes the one or more processors of any of examples 1 to 13, where the PPA contextual data report includes at least one of a network context share or a UE context share.

Example 15 includes the one or more processors of example 14, where the PPA contextual data report further includes a SNIP to use for validation of the network context share or the UE context share.

Example 16 includes the one or more processors of any of examples 1 to 15, where transmitting the PPA contextual data report in accordance with the second request includes transmitting an RRC message or a NAS message including the PPA contextual data report.

Example 17 includes the one or more processors of any of examples 1 to 16, where transmitting the PPA contextual data report in accordance with the second request includes transmitting the PPA contextual data report during an established uplink PDU session.

Example 18 includes one or more processors configured to, when executing instructions stored in a memory, perform operations including: instructing RF circuitry to transmit a first request for PPA capability information; receiving, via the RF circuitry, the PPA capability information in accordance with the first request; instructing the RF circuitry to transmit a second request for a PPA contextual data report, where the second request is based on the PPA capability information; and receiving, via the RF circuitry, the PPA contextual data report in accordance with the second request.

Example 19 includes the one or more processors of example 18, where the PPA capability information indicates a capability to provide at least one of network context information or UE context information.

Example 20 is a method including: receiving a first request for PPA capability information; transmitting the PPA capability information in accordance with the first request; receiving a second request for a PPA contextual data report; and transmitting the PPA contextual data report in accordance with the second request.

Example 21 is a UE that includes one or more processors and memory storing instructions that, when executed by the one or more processors, cause the UE to perform the operations of any of examples 1-17.

Example 22 is a base station that includes one or more processors and memory storing instructions that, when executed by the one or more processors, cause the base station to perform the operations of any of examples 18-19.

Any of the examples described above can be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device.

In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. One or more processors configured to, when executing instructions stored in a memory, perform operations comprising:
receiving, via radio frequency (RF) circuitry, a first request for privacy-preserving aggregation capability information;
instructing the RF circuitry to transmit the privacy-preserving aggregation capability information in accordance with the first request;
receiving, via the RF circuitry, a second request for a privacy-preserving aggregation contextual data report; and
instructing the RF circuitry to transmit the privacy-preserving aggregation contextual data report in accordance with the second request.

2. The one or more processors of claim 1, wherein the privacy-preserving aggregation capability information indicates a capability to provide at least one of network context information or UE context information.

3. The one or more processors of claim 2, wherein the network context information comprises one or more network measurements that include at least one of a reference signal received power (RSRP), a reference signal received quality (RSRQ), or a signal to interference and noise ratio (SINR).

4. The one or more processors of claim 3, wherein the privacy-preserving aggregation contextual data report comprises one or more cryptographically secure input shares containing data associated with the one or more network measurements.

5. The one or more processors of claim 2, wherein the network context information comprises one or more network configuration parameters that include at least one of a frequency band, a radio access technology (RAT), a beam index, or a number of layers.

6. The one or more processors of claim 5, wherein the privacy-preserving aggregation contextual data report comprises one or more cryptographically secure input shares containing data associated with the one or more network configuration parameters.

7. The one or more processors of claim 2, wherein the UE context information comprises at least one of UE location information or UE application status information.

8. The one or more processors of claim 7, wherein the privacy-preserving aggregation contextual data report comprises one or more cryptographically secure input shares containing data associated with the UE location information or the UE application status information.

9. The one or more processors of claim 2, wherein the privacy-preserving aggregation capability information comprises at least one of a granularity level, a cryptographic protocol, a differential privacy scheme, or a noise level to use for privacy-preserving aggregation of the network context information or the UE context information.

10. The one or more processors of claim 2, wherein the second request for the privacy-preserving aggregation contextual data report includes a request for at least some of the network context information or the UE context information.

11. The one or more processors of claim 2, wherein the second request for the privacy-preserving aggregation contextual data report indicates at least one of a granularity level, a cryptographic protocol, a differential privacy scheme, or a noise level to use for privacy-preserving aggregation of the network context information or the UE context information.

12. The one or more processors of claim 1, wherein transmitting the privacy-preserving aggregation contextual data report in accordance with the second request comprises transmitting the privacy-preserving aggregation contextual data report to one or more aggregation nodes identified by the second request.

13. The one or more processors of claim 12, wherein the one or more aggregation nodes comprise at least one of a radio access network (RAN) node, a core network (CN) node, or an application service provider (ASP) node.

14. The one or more processors of claim 1, wherein the privacy-preserving aggregation contextual data report comprises at least one of a network context share or a UE context share.

15. The one or more processors of claim 14, wherein the privacy-preserving aggregation contextual data report further comprises a secret shared non-interactive proof (SNIP) to use for validation of the network context share or the UE context share.

16. The one or more processors of claim 1, wherein transmitting the privacy-preserving aggregation contextual data report in accordance with the second request comprises transmitting a radio resource control (RRC) message or a non-access stratum (NAS) message comprising the privacy-preserving aggregation contextual data report.

17. The one or more processors of claim 1, wherein transmitting the privacy-preserving aggregation contextual data report in accordance with the second request comprises transmitting the privacy-preserving aggregation contextual data report during an established uplink protocol data unit (PDU) session.

18. One or more processors configured to, when executing instructions stored in a memory, perform operations comprising:
instructing radio frequency (RF) circuitry to transmit a first request for privacy-preserving aggregation capability information;
receiving, via the RF circuitry, the privacy-preserving aggregation capability information in accordance with the first request;
instructing the RF circuitry to transmit a second request for a privacy-preserving aggregation contextual data report, wherein the second request is based at least in part on the privacy-preserving aggregation capability information; and
receiving, via the RF circuitry, the privacy-preserving aggregation contextual data report in accordance with the second request.

19. The one or more processors of claim 18, wherein the privacy-preserving aggregation capability information indicates a capability to provide at least one of network context information or UE context information.

20. A method comprising:
receiving a first request for privacy-preserving aggregation capability information;
transmitting the privacy-preserving aggregation capability information in accordance with the first request;
receiving a second request for a privacy-preserving aggregation contextual data report; and
transmitting the privacy-preserving aggregation contextual data report in accordance with the second request.
